(19) United States
(12) Patent Application Publication
(10) Pub. No.: US 2026/0080513 A1
(43) Pub. Date: Mar. 19, 2026

(54) NEURAL SPLINE FIELDS FOR IMAGE FEATURE SEPARATION

(71) Applicant: The Trustees of Princeton University, Princeton, NJ (US)

(72) Inventors: Ilya CHUGUNOV, Princeton, NJ (US); David SHUSTIN, Millburn, NJ (US); Ruyu YAN, Princeton, NJ (US); Chenyang LEI, Princeton, NJ (US); Felix HEIDE, Princeton, NJ (US)

(21) Appl. No.: 19/332,887

(22) Filed: Sep. 18, 2025

Related U.S. Application Data
(60) Provisional application No. 63/696,130, filed on Sep. 18, 2024.

(51) Int. Cl. G06T 5/60; G06T 7/246

(52) U.S. Cl. CPC G06T 5/60; G06T 7/251

(57) ABSTRACT

Methods and systems are described for analyzing images. One or more machine learning models may be trained based on a plurality of images. The one or more machine learning models may comprise a model representing a feature in a scene. The one or more machine learning models may be trained to map input image coordinates to vectors of spline control points. Images may be reconstructed removing the feature from the scene.

### CROSS-REFERENCE TO RELATED APPLICATIONS

This application is related to U.S. Patent Application No. 63/696,130 filed Sep. 18, 2024, which is hereby incorporated by reference for any and all purposes.

### BACKGROUND

Modern smartphones and other camera devices increasingly rely on computational photography to enhance image quality, especially in challenging conditions like low light or high dynamic range. These devices often capture bursts of images and use software to merge them into a single, high-quality photo. However, this process can struggle with issues like occlusions, reflections, and motion blur, which obscure or distort parts of the scene. Thus, there is a need for more sophisticated methods for processing images.

### SUMMARY

The present disclosure provides methods, systems, and devices for image processing. An example method may comprise determining a plurality of images associated with a camera device. The method may comprise generating a camera model indicative of the camera device in a three dimensional space. The method may comprise generating, based on the plurality of images, at least one neural network trained to map input image coordinates to vectors of spline control points. The method may comprise generating, based on the camera model and the at least one neural network, at least one reconstructed image. The method may comprise causing storage of the at least one reconstructed image. An example device may comprise any device configured to perform the method, such as a computing device with memory and one or more processors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

The patent or application file contains at least one drawing executed in color. Copies of this patent or patent application publication with color drawing(s) will be provided by the Office upon request and payment of the necessary fee.

FIG. 1 shows an example system as contemplated by the present disclosure.

FIG. 2 shows an exemplary method as contemplated by the present disclosure.

FIG. 3 shows a schematic demonstrating fitting an exemplary two-layer neural spline field model to a stack of images in order to be able to directly estimate and separate even severe, out-of-focus obstructions to recover hidden scene content.

FIG. 4 shows exemplary image and flow estimates for different representations of a short video sequence of a swinging branch.

FIG. 5 shows exemplary image fitting results for coordinate networks with Small (Lγ=8) and Large (Lγ=16) multi-resolution hash encodings and identical other parameters.

FIG. 6 is an exemplary model of an input image sequence as the alpha composition of a transmission and obstruction plane.

FIG. 7 shows exemplary reconstruction results for noisy, low-light conditions.

FIG. 8 shows exemplary occlusion removal results and estimated alpha maps for a set of captures with reference views.

FIG. 9 shows exemplary layer separation results in unique real-world cases enabled by our generalizable two-layer image model.

FIG. 10 shows exemplary qualitative and quantitative obstruction removal results for a set of synthetic scenes with paired ground truth, camera motion simulated from real measured hand shake data.

FIG. 11 shows exemplary reflection removal results and estimated alpha maps for a set of captures with reference views.

FIG. 12 shows exemplary layer separation results for additional example applications of shows shadow removal, image dehazing, and video motion segmentation.

FIG. 13 shows an exemplary learned flow estimator RAFT and segmentation model SAM struggle to produce meaningful outputs for a small-motion scene with an out-of-focus occluder.

FIG. 14 shows a tripod-mounted occluder setup for capturing paired occlusion removal data, a tripod-mounted reflector setup for capturing paired reflection removal data, an exemplary capture application interface with the extended settings menu, and an example 3D scene with simulated occluder, camera frustum highlighted.

FIG. 15 shows exemplary image fitting results for network encoding configurations as described in Table. 1.

FIG. 16 shows exemplary occlusion removal results and estimated alpha maps for a set of captures with reference views, with comparisons to single image, multi-view, and NeRF fitting approaches.

FIG. 17 shows exemplary reflection removal results and estimated alpha maps for a set of captures with reference views, with comparisons to single image, multi-view, and NeRF fitting approaches.

FIG. 18 shows exemplary shadow removal results under different lighting conditions including partially diffuse, multiple point, and single point.

FIG. 19 shows exemplary reflection removal results for challenging in-the-wild scenes.

FIG. 20A shows exemplary qualitative and quantitative occlusion removal results for a set of 3D rendered scenes with paired ground truth.

FIG. 20B shows exemplary qualitative and quantitative occlusion removal results for another set of 3D rendered scenes with paired ground truth.

FIG. 20C shows exemplary qualitative and quantitative occlusion removal results for another set of 3D rendered scenes with paired ground truth.

FIG. 21A shows exemplary qualitative and quantitative reflection removal results for a set of 3D rendered scenes with paired ground truth.

FIG. 21B shows exemplary qualitative and quantitative reflection removal results for another set of 3D rendered scenes with paired ground truth.

FIG. 21C shows exemplary qualitative and quantitative reflection removal results for another set of 3D rendered scenes with paired ground truth.

FIG. 22 shows exemplary challenging image reconstruction cases including varying scales of camera motion, overlap between occluder and transmission colors, and residual signal left on scene content in low-texture regions.

FIG. 23 shows visualization of the effects of gradient loss [symbol] _{G} on image reconstruction at 25× zoom.

FIG. 24A shows an exemplary ablation study of a digger on the effects of the number of input frames or duration of capture on transmission layer reconstruction and estimated alpha matte.

FIG. 24B shows an exemplary ablation study of gloves on the effects of the number of input frames or duration of capture on transmission layer reconstruction and estimated alpha matte.

FIG. 25 shows results from an exemplary ablation study on the effects of alpha regularization weight ηα on transmission layer reconstruction and estimated alpha matte.

FIG. 26 shows results from an exemplary ablation study on the effects of flow encoding size on transmission layer reconstruction and estimated alpha matte.

FIG. 27 shows a demonstration of user-interactive scene editing facilitated by layer separation.

FIG. 28 shows an example computing device for implementing any of the devices of the present disclosure.

### DETAILED DESCRIPTION OF ILLUSTRATIVE EMBODIMENTS

Over the last decade, as digital photos have increasingly been produced by smartphones, smartphone photos have increasingly been produced by burst fusion. To compensate for less-than-ideal camera hardware—typically restricted to a footprint of less than 1 cm³—smartphones rely on their advanced computer hardware to process and fuse multiple lower-quality images into a high-fidelity photo. This may be particularly important in low-light and high-dynamic-range settings, where a single image must compromise between noise and motion blur, but multiple images afford the opportunity to minimize both. But even as mobile night- and astro-photography applications use increasingly long sequences of photos as input, their output remains a static single-plane image. Given the typically non-static and non-planar nature of the real world, a core problem in burst image pipelines is the alignment and aggregation of pixels into an image array—referred to as the align-and-merge process.

While existing approaches treat pixel motion as a source of noise and artifacts, a parallel direction of work attempts to extract useful parallax cues from this pixel motion to estimate the geometry of the scene. Recent work by Chugunov et al. finds that maximizing the photometric consistency of an RGB plus depth neural field model of an image sequence is enough to distill dense depth estimates of the scene. While this method is able to jointly estimate high-quality camera motion parameters, it does not perform high-quality image reconstruction, and rather treats its image model as “a vehicle for depth optimization”. In contrast, work by Nam et al. proposes a neural field fitting approach for multi-image fusion and layer separation which focuses on the quality of the reconstructed “canonical view”. By swapping in different motion models, they can separate and remove layers such as occlusions, reflections, and moiré patterns during image reconstruction—as opposed to in a separate post-processing step. This approach, however, does not make use of a realistic camera projection model, and relies on regularization penalties to discourage its motion models from representing non-physical effects—e.g., pixel tearing or teleportation.

It should be understood that the neural spline field model of flow described herein is itself novel and adds a technical improvement over prior approaches that relied on flow. The present techniques are an improvement over prior technical approaches because of at least one of: the use of a realistic camera model, and an updated flow model (e.g., the neural spline field model).

The present disclosure may be understood more readily by reference to the following detailed description of desired embodiments and the examples included therein. The present disclosure provides an end-to-end neural scene fitting approach which fits to a burst image sequence to distill high-fidelity camera poses, and high-resolution two-layer transmission plus occlusion image decomposition. Also provided herein is a compact, controllable neural spline field model to estimate and aggregate pixel motion between frames. The qualitative and quantitative evaluations performed herein demonstrate that the disclosed model outperforms existing single image and multi-frame obstruction removal approaches.

Rather than represent flow as a 3D volume—a function of x,y and time—the disclosure proposes neural spline fields (NSFs) as a compact alternative flow model. These NSFs may comprise coordinate networks which map an input x,y point to a vector of spline control points. These NSFs may be evaluated at the sample time just like an ordinary spline to produce flow estimates, meaning the temporal behavior of the NSF outputs may be directly controlled by its chosen spline parametrization. The disclosure demonstrates that this flow representation, without any regularization, fits to produce temporally consistent flow estimates that agrees with a conventional optical flow reference.

The use of neural spline fields in this context is an improvement of the prior technical approaches. Neural spline fields are an improvement to the technical field because they are self-regularized. Neural spline fields provide a lot more parameters to adjust than a general flow volume. For example, for the spline field you can control how fast it changes over time by controlling the number of spline parameters (e.g., enforcing smooth motion by setting it to a low number). And you can enforce spatial smoothness by setting the size of the spatial grid (e.g., in x,y), making it smooth over space by making the grid small/interpolated. In other words, neural spline fields are much more controllable than conventional techniques.

The disclosure leverages the strong spatial controls provided by multi-resolution hash encodings to allocate spatial complexity only to where it is needed in an image formation model. Networks are provided such as those responsible for the transmission image high-resolution grid encodings to perform detailed reconstruction of the input 12-megapixel image data. Flow models may be restricted to low-resolution grids to ensure spatial consistency.

Fit to a burst of images (e.g., two second burst), the disclosed models may use the motion from natural hand tremor to separate content into obstruction and transmission layers. This layer separation may be used to remove occlusions, suppress reflections, and reveal unseen content in both layers. For example, the disclosed approach may be used to remove hard reflections, out-of-focus fences, or even occluders that cover more of the scene than they let through. The disclosed approach can fit a wide range of obstructions and environments to produce high-quality layer separation results. The training time may be substantially low given training for a specific set of images is performed. For example, a training time on a single RTX 4090 may be only about three minutes.

The disclosure provides, as an example, a two-layer image-plus-flow model to be as versatile as possible, able to perform tasks ranging from classic align-and-merge image denoising to photographer-cast shadow removal. Any scene which is the product of multiple motion models—whether that motion be from the subject, the camera, or the lights themselves—has the potential to be separated into multiple image layers.

The disclosed methods, systems, and devices may include generating a versatile layered neural image representation with a projective camera model and novel neural spatio-temporal spline parametrization. The disclosed methods, systems and devices provide an example model that takes as input an unstabilized 12-megapixel RAW image sequence, camera metadata, and gyroscope measurements—available on all modern smartphones. During test-time optimization, a fitting process may be performed to produce a high-resolution reconstruction of the scene, separated into transmission and obstruction image planes. The latter of which can be extracted to perform occlusion removal, reflection suppression, and other layer separation applications. To this end, pixel motion between burst frames may be decomposed into planar motion, from the camera's pose change in 3D space relative to the image planes, and a generic flow component which accounts for depth parallax, scene motion, and other image distortions. These flows may be modeled with neural spline fields (NSFs), which may be networks trained to map input coordinates to spline control points. The NSFs may be interpolated at sample timestamps to produce flow field values. As their output dynamics may be strictly bound by their spline parametrization, these NSFs may produce temporally consistent flow with no regularization, and can be controlled spatially through the manipulation of their positional encodings.

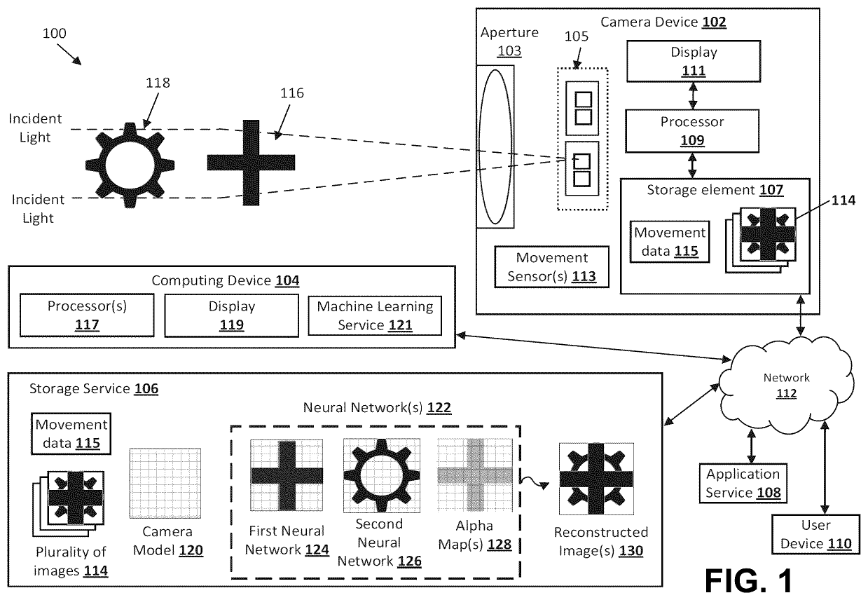

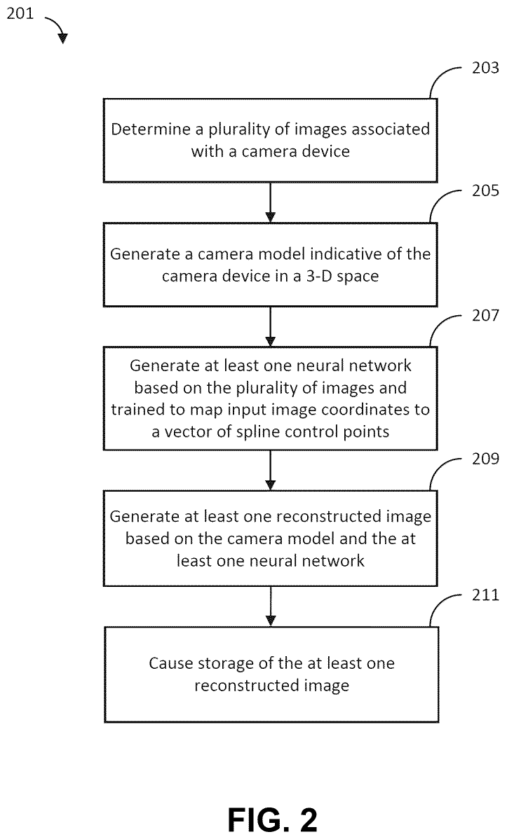

FIG. 1 shows an example system for image analysis in accordance with the present disclosure. The system 100 may comprise a camera device 102, a computing device 104, storage service 106, an application service 108, a user device 110, or any combination thereof. One or more of the camera device 102, the computing device 104, the storage service 106, the application service 108, the user device 110 may each be implemented as a single computing device or a combination of devices. For example, the computing device 104 may be one device (e.g., or a virtual machine running thereon) of a plurality of computing devices in a cloud computing infrastructure. Any one or a combination of the devices the system 100 may implement the method of FIG. 2.

One or more of the camera device 102, the computing device 104, the storage service 106, the application service 108, the user device 110 may be communicatively coupled via a network 112 (e.g., a local area network, a wide area network, or a combination thereof). The network 112 may comprise wired links, wireless links, a combination thereof, and/or the like. The network 112 may comprise routers, switches, nodes, gateways, servers, modems, and/or the like.

The camera device 102 may comprise a sensing device, user device, mobile device, handheld camera, mobile camera, mobile telephone, microscope, telescope, light field camera, time-of-flight camera, hyperspectral camera, server device, x-ray computed tomography device, or any combination thereof. The camera device 102 may comprise an aperture 103 for receiving light. The camera device 102 may comprise a plurality of sensors 105 configured to detect the light to capture (e.g., generate, determine) images. The camera device 102 may comprise a storage element 107 for storing images, computer readable code, and/or the like. The camera device 102 may comprise a processor 109. The camera device 102 may comprise a display 111 for display images, a user interface, and/or the like. The camera device 102 may comprise one or more movement sensors 113. The movement sensor(s) may comprise a gyroscope, accelerometer, and/or the like.

The camera device 102 may be configured to capture a plurality of images 114. The plurality of images 114 may represent a first object 116 and a second object 118 in an environment (e.g., physical environment). The first object 116 may comprise (e.g., or represent) a foreground of the plurality of images 114. The second object 118 may comprise (e.g., or represent) a background of the plurality of images 114. The first object 116 may comprise a reflection, noise, a physical object, obstruction blocking view of the second object 118, or a combination thereof. The plurality of images 114 may be offset from each other in space due to motion of the camera device 102 while capturing the plurality of images (e.g., at least one image may be taken from another point in space than another image). The plurality of images 114 may comprise a sequence of images, a burst of images captured over at least 2 seconds, a burst of images captured over at least 1 second, a burst of images captured in a range of about 0.5 seconds to 2 seconds, a sequence in a range of about 10 to about 40 frames, or a combination thereof.

The movement sensor(s) 113 may generate movement data 115. The movement data may indicate changes in the physical location of the camera device 102. The movement data 115 may correspond to movement of the camera device 102 while the plurality of images 114 were being captured. The camera device 104 may be configured to send the plurality of images 114, the movement data 115, or a combination thereof to the storage service 106 (e.g., one or more computing devices storing data). The computing device 104 may perform analysis on the plurality of images 114, such as generating one or more machine learning models, and/or the like for generating reconstructed images. The reconstructed images may be representative of one or more features (e.g., objects, background, foreground, reflections) of the plurality of images 114. It should be understood that in some implementations, any one or combination of the features, configurations, and/or actions performed by the computing device 104, storage service 106, application service 108, and user device 110 may be implemented (e.g., in part, or in whole) on the camera device 102 instead.

The storage service 106 may be configured to store data for one or more devices of the system. Though shown as separate devices, it should be understood that in some scenarios, the storage service 106 and the computing device 104 may be integrated into a single device. The storage service 106 may be configured to receive the plurality of images 114, the movement data 115, or a combination thereof from the camera device 102. The plurality of images 114, the movement data 115, or a combination thereof may be stored by the storage service, such as for analysis by the computing device 104. The analysis by the computing device 104 may cause generation (e.g., and storage thereof by the storage service 106) of at least one machine learning model (e.g., at least one neural network). The analysis by the computing device 104 may cause generation (e.g., and storage thereof by the storage service 106) of at least one reconstructed image.

The application service 108 may be configured to provide one or more services, such as account services, application services, network services, image analysis services, or a combination thereof. Though shown as separate devices, it should be understood that in some scenarios, the application service 108, the storage service 106, the computing device 104, or any combination thereof may be integrated into a single device. The application service 108 may comprise services for one or more applications on the user device 110. The application service 108 may generate application data associated with the one or more application services. The application data may comprise data for a user interface, data to update a user interface, data for an application session associated with the user device 110, and/or the like. The application data may comprise data associated with access, control, and/or management of images generated by the camera device 102.

The user device 110 may comprise a computing device, a smart device (e.g., smart glasses, smart watch, smart phone), a mobile device, a tablet, a computing station, a laptop, a digital streaming device, a television, and/or the like. In some scenarios, the user device 110 and the camera device 102 may be integrated together into a single device. In some scenarios, a user may have multiple user devices, such as a mobile phone, a smart watch, smart glasses, a combination thereof, and/or the like. The user device 110 may be configured to communicate with the camera device 102, the computing device 104, the storage service 106, the application service 108, and/or the like. The user device 110 may be configured to output a user interface. The user interface may be output via the user interface via an application, service, and/or the like, such as an image browser. The user interface may receive application data from the application service 108 (e.g., camera device 102). The application data may be processed by the user device 110 to cause display of the user interface. For example, the user interface may provide a plurality of images. The user interface may be configured to cause the computing device 104 to perform image analysis, such a generating one or more reconstructed images (e.g., using the method shown in FIG. 2 and described throughout). The user may select a one or more of a plurality of images and request that a reconstructed image be generated, such as one that removes an obstruction, noise, a reflection, and/or the like.

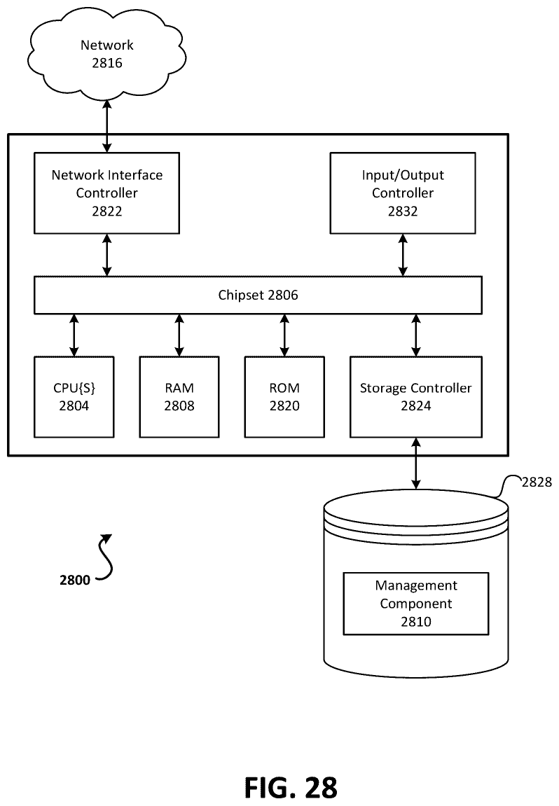

The computing device 102 may comprise one or more processors 117, a display 119, or a combination thereof (e.g., such as any of the features of FIG. 28). The computing device 102 may comprise a machine learning service 121. The machine learning service 121 may be configured to train one or more machine learning model, such as neural networks, and/or any other machine learning model. As described in more detail, the machine learning service 121 may be configured to perform a repetitive training process to train the one or more machine learning models. For example, an optimization and/or loss process may be repeatedly performed to train one or more machine learning models to achieve a certain output based on a specific input.

The computing device 104 (e.g., or camera device 102, user device 110) may be configured to determine (e.g., receive from the camera device 102, access at the storage service 106, and/or the like) the plurality of images 114. Determining the plurality of images associated with the camera device 102 may comprise one or more of receiving the plurality of images 114 from the camera device 102, capturing the plurality of images 114, or accessing the plurality of images 114 in storage (e.g., via storage service 106, or local memory storage). The computing device 104 (e.g., or camera device 102, user device 110) may be configured to receive the movement data 115 indicative of movement while at least a portion of the plurality of images 114 are captured. The movement data 115 may comprise sensor metadata, gyroscope measurements, accelerometer data, or camera metadata.

The computing device 104 (e.g., or camera device 102, user device 110) may be configured to generate a camera model 120 indicative of the camera device 102 in a space (e.g., a three dimensional space). The computing device 104 (e.g., or camera device 102, user device 110) may be configured to initialize the camera model 120 based on the movement data 115 by specifying one or more of a location of the camera device, a rotation of the camera device, an angle of the camera device, or a translation of the camera device.

The computing device 104 (e.g., or camera device 102, user device 110) may be configured to generate (e.g., or determine) at least one neural network 122 (e.g., or other machine learning model). The at least one neural network 122 may be configured to separate one or more foreground features from a background. The one or more foreground features may comprise one or more of occlusions, reflections, shadows, or noise. The at least one neural network 122 may comprise one or more layers (e.g., each one being a separate neural network). The one or more layers may comprise an obstruction layer, a transmission layer and/or a combination thereof. The at least one neural network may comprise a first neural network 124. The first neural network 124 may represent a feature in a first plane (e.g., first object 116) of the camera model 120. The at least one neural network 122 may comprise a second neural network 126. The second neural network 125 may represent a feature in a second plane (e.g., second object 118) of the camera model 120. The first neural network 124 may comprise a first neural field flow network representing motion of at least one object in the first plane in the three dimensional space. The second neural network 126 may comprise a second neural field flow network representing motion of at least one object in the second plane in the three dimensional space. The first plane may represent an obstruction layer. The second plane may represent a transmission layer. The first plane may be located in between the second plane and the camera device 102 in the three dimensional space of the camera model 120.

Generating the at least one neural network 122 (e.g., the first neural network 124) may comprise generating data representing a first neural field flow for a first two dimensional plane object at a first location in three dimensional space in the cameral model. Generating the at least one neural network 122 (e.g., the second neural network 124) may comprise training the first neural field flow based on using the first neural field flow to generate an approximate image and minimizing a difference between the approximate image an image of the plurality of images.

Generating the at least one neural network 122 (e.g., the second neural network 126) may comprise generating data representing a second neural field flow for a second two dimensional plane object at a second location in three dimensional space in the camera model 120. Generating the at least one neural network 122 (e.g., the second neural network 126) may comprise training the second neural field flow based on using the second neural field flow to generate the approximate image and minimizing the difference between approximate image and the image of the plurality of images.

The at least one neural network 122 (e.g., the first neural network 124, the second neural network 126, or a combination thereof) may comprise at least one neural spline field model of flow. The neural spline field model may comprise a continuous flow representation based on fitting a polynomial function to the spline control points. The at least one neural network 122 may be trained to map input image coordinates to vectors of spline control points. The at least one neural network 122 may map a coordinate of an image to color values at each of the spline control points. Each spline control point may represent a different point of time relative to the plurality of images. For example, each point on a plane of a neural network may map to a flow vector that may shift a ray's intersection to correct for motion effects (e.g., differences in the plurality of images 114 due to motion of the camera device 102)

The at least one neural network 122 (e.g., the first neural network 124, the second neural network 126, or a combination thereof) may be generated based on the plurality of images 114. The at least one neural network 122 may be trained such that pixels blocked by an obstruction in one image may be reconstructed using based on pixels in another image of the plurality of images. The spline control points may comprise locations on a polynomial function. Generating the at least one neural network 122 may comprise training the at least one neural network 122 based on stochastic gradient descent.

Generating the at least one neural network 122 may comprise generating at least one alpha map 128. The at least one alpha map 128 may comprise an actual alpha map and an inverse alpha map. The at least one alpha map 128 may comprise at least one neural field based alpha map. The at least one alpha map 128 may indicate locations of pixels of one or more of an obstruction or a reflection in the plurality of images. The at least one alpha map 128 may indicate a foreground (e.g., obstruction, reflection, noise) feature (e.g., pixels indicating the foreground feature may not be non-transparent, while pixels not representing the foreground may be set as full or partial transparency). The inverse alpha map may indicate an inverse of the foreground feature (e.g., pixels indicating the foreground feature may have full or partial transparency, while pixels not representing the foreground may be set as non-transparent).

Generating the at least one neural network 122 may comprise optimizing a photometric reconstruction loss (e.g., using the machine learning service 121). The at least one neural network 122 may be trained to separate a foreground feature from background in the plurality of images 114. For example, the first neural network 124 may be initialized. The second neural network 126 may be initialized. The alpha map 128 may be initialized. Initialization may be based on default data. An image may be generated based on tracing a ray passing through the first neural network 124 (e.g., or data indicative of the first neural network 124) and the second neural network 126 (e.g., first passing through the first neural network 124, then passing through the second neural network 126). The first neural network 124 may be multiplied by the alpha map 128. The second neural network 126 may be multiplied by the inverse of the alpha map 128. The results of these multiplications may be composited together to form a resulting image. In some scenarios, each ray samples some RGB1 (e.g., first neural network 124), Alpha, RGB2 (e.g., second neural network 126), which is composited along the ray back to the final image.

The resulting image may be compared to one of the plurality of images 114. The photometric reconstruction loss may be determined based on comparing the generated image to the actual image (e.g., comparing pixel values from one image to the other). One or more of the first neural network 124, the second neural network 126, or the alpha map 128 may be updated based on the photometric reconstruction loss. Another image may be generated based on tracing a ray passing through the first neural network 124 and the second neural network 126. The process may be iteratively repeated, each time generating a new image and determining a photometric reconstruction loss, until the at least one neural network 122 are trained (e.g., based on achieving a threshold reconstruction loss, after a certain number of iterations, and/or the like).

The computing device 104 (e.g., or camera device 102, user device 110) may be configured to generate at least one reconstructed image 130. The at least one reconstructed image 130 may modify, remove, add, or a combination thereof one or more of an object or a plane from one of the plurality of images. For example, the at least one reconstructed image 130 may remove a foreground feature. The foreground feature may comprise one or more of occlusions, obstructions, reflections, shadows, noise, or a combination thereof. The at least one reconstructed image may comprise a reconstructed background without the foreground feature.

The at least one reconstructed image 130 may be generated based on the camera model 120, the at least one neural network 122, or a combination thereof. Generating the at least one reconstructed image 130 may comprise using the at least one neural network 122 to interpolate a color value for a pixel based on more than one spline control point associated with the pixel. The at least one reconstructed image 130 may comprise a neural field image. The at least one reconstructed image 130 may comprise a first image representing a first plane of the three dimensional space. The first image may be generated based on the first neural network 124 (e.g., by tracing rays in the camera model 120 through the first neural network 124). The second image may be generated without the second neural network 126. The at least one reconstructed image 130 may comprise a second image representing a second plane of the three dimensional space. The second image may be generated based on the second neural network 126 (e.g., by tracing rays in the camera model 120 through the second neural network 126. The second image may be generated without the first neural network 124.

As an example, layer 1 (e.g., first neural network 124) and/or layer 2 (e.g., second neural network 126) may be sampled individually with neural spline field flow. Next, both layer 1 and layer 2 may be sampled together with neural spline field flow and fused together. Next, either one of layer 1 or layer 2 may be sampled without the flow (e.g., basically just use the flow during training and then throw it away). Next, layer 1 and layer 2 may be sampled without flow/fuse together. Next, perform same operation may be performed with the 3D camera model. It is possible to keep or remove the camera motion itself (e.g., which can be useful for things like image/video stabilization, setting the camera motion to zero or some smooth path).

The computing device 104 (e.g., or camera device 102, user device 110) may be configured to cause storage of the at least one reconstructed image 130 (e.g., at the storage service 106, at the camera device 102, at the user device 110). The at least one reconstructed image 130 may be viewed by a user using the user interface (e.g., provided at the user device 110 and/or the camera device 102).

In some implementations, the computing device may be configured to perform a training process specific to a given sequence (e.g., burst) of images. During this process, the system may receive a sequence of images captured over a short duration-such as a two-second handheld burst—and uses movement data (e.g., gyroscope readings) to initialize a camera model in three-dimensional space. A neural network may then be trained to map image coordinates to vectors of spline control points, which represent pixel motion over time. This training is performed per image burst and may be completed in short time (e.g., a matter of minutes or less than a minute on modern hardware, such as a desktop GPU). Once trained, the system can analyze the image sequence to separate foreground features (e.g., occlusions, reflections, shadows) from background content. Using the learned flow and camera model, the system reconstructs one or more high-fidelity images that reveal hidden or clearer scene content. This process is typically initiated after image capture, such as when a user selects a photo for enhancement or requests removal of an obstruction via a user interface.

In some implementations, the computing device 104 (e.g., or camera device 102, or use device 110) may be configured to perform a per-capture optimization process after a burst of images is recorded. For example, when a user takes a photo using a smartphone camera, the device may capture a short sequence of frames-typically over one to two seconds-along with motion data from onboard sensors, such as a gyroscope. Rather than relying on pre-trained models, the system may train a neural network specific to that burst, using the captured data to estimate camera motion and pixel flow. This training process, which may take only a few minutes or less on modern hardware, enables the system to perform operations that reveal or clarify information in a scene, such as separate foreground obstructions (e.g., fences, reflections, shadows) from background content and reconstruct a high-fidelity image that reveals hidden or occluded details. This process may be initiated automatically after capture or triggered by the user selecting an enhancement option, such as “remove obstruction” or “clean up image,” within the camera or gallery application. Because the training is tailored to the specific burst, it does not require the camera to remain pointed at the scene after capture. However, the camera may be pre-programmed (e.g., by default, or by user selecting some kind enhancement setting) to take multiple frames (e.g., a burst or sequence) even if the user only presses the image capture button once. These frames and motion data may be used immediately after to perform the image processing or may be stored for later usage, such as if the user selects a photo and requests a particular type of enhancement. This user selection (e.g., or other setting) may trigger the training of one or more neural networks based on the bust of images associated with a user capture of a photo. The particular type of training and machine learning model may depend on the type of enhance requested by the user.

In other implementations, the system may be deployed on specialized imaging devices, such as microscopes or telescopes. For instance, a microscope may capture a burst of frames while the sample or stage is slightly shifted (e.g., by some kind of motor or other transducer), allowing the system to reconstruct a clearer image by removing noise or optical artifacts. Similarly, a telescope may use burst imaging (e.g., while slightly vibrating the telescope) to suppress atmospheric distortion, reflections from nearby surfaces, or perform other enhancements. In industrial or scientific settings, devices such as hyperspectral cameras or x-ray computed tomography systems may use the disclosed methods to separate overlapping features or enhance visibility of structures obscured by noise or interference. In each case, the training and reconstruction process is tailored to the specific burst of data and may be performed locally on the device or remotely via a connected computing system.

Referring now to FIG. 2, the present disclosure provides one or more methods 201 for image analysis. The method 200 may comprise a computer implemented method for providing a service (e.g., image analysis service, image generation service, image modification service). A system and/or computing environment, such as the system 100 of FIG. 1 and/or the computing environment of FIG. 28, may be configured to perform the method 200. Any step or combination of steps of the method 200 may be performed by a computing device, network device, and/or user device, such as any of the devices shown in FIG. 1 (e.g., such as the camera device 102, the computing device 104, the storage service 106, the application service 108, the user device 110, or a combination thereof). Any of the features of the method of FIG. 2 may be combined with any of the features and/or methods described further herein.

At step 203 of method 201, a plurality of images (e.g., the plurality of images 114) associated with an acquisition device (e.g., a camera device 102) may be determined. The plurality of images may be offset from each other in space due to motion of the acquisition device (e.g., camera device 102) while capturing the plurality of images. The plurality of images may comprise a sequence of images, a burst of images captured over at least 2 seconds, a burst of images captured over at least 1 second, a burst of images captured in a range of about 0.5 seconds to 2 seconds, a sequence in a range of about 10 to about 40 frames, or a combination thereof. Determining the plurality of images may comprise one or more of receiving the plurality of images from the camera device, capturing the plurality of images, or accessing the plurality of images in storage. The acquisition device (e.g., camera device 102) may comprise one or more of a user device, mobile device, handheld camera, mobile camera, mobile telephone, microscope, telescope, and light field camera, time-of-flight camera, hyperspectral camera, server device, or x-ray computed tomography device.

The method 201 may comprise receiving movement data indicative of movement while at least a portion of the plurality of images are captured. The movement data may be received with (e.g., or separately from) the plurality of images. The movement data may comprise sensor metadata, gyroscope measurements, accelerometer data, or camera metadata.

At step 205, a camera model indicative of the camera device in a three-dimensional space may be generated. The method 201 may comprise initializing the camera model based on the movement data. The camera model may be initialized based on the movement data by specifying one or more of a location of the camera device, a rotation of the camera device, an angle of the camera device, or a translation of the camera device.

The camera model may comprise a pinhole camera model. The camera model may include translation, rotation, and/or other parameters for each time point (e.g., each frame in the video) of the camera device 102. For each time point (e.g., each frame in the video), the camera model may indicate a translation and/or rotation (e.g., 3D vectors XYZ, optionally modeled as splines) for the camera device 102. Translation in the camera model may be learned (e.g., or otherwise determined), such as by initializing all the cameras at (0,0,0) and letting the cameras float around during optimization. Rotation in the camera model may be initialized from the camera devices 102 gyroscope. Other parameters used to make rays like the focal length (e.g., where the camera is focused) and/or lens distortion (e.g., a correction term because sometimes the lens will fish-eye or otherwise bend light) may be determined (e.g., taken) from the camera device 102 metadata (e.g., as estimated by the manufacturer). In some scenarios, these same parameters may be learned or estimated during the optimization process.

At step 207, at least one neural network may be generated. The at least one neural network may be configured to separate one or more foreground features from a background (e.g., in the plurality of images). The one or more foreground features may comprise one or more of occlusions, reflections, shadows, objects, or noise. The at least one neural network may be trained to map input image coordinates to vectors of spline control points. The neural network may take as input an image coordinate (e.g., pixel location) and output a vector (e.g., or other data structure, such as an object or array) of spline control points. The at least one neural network may map a coordinate of an image to color values at each of the spline control points. Each spline control point may represent a different point of time relative to the plurality of images. The spline control points may comprise locations on a polynomial function and/or flow model. The locations may represent time points in the flow model, each time point having an associated location (e.g., or predicted location) of a specified pixel at that time point.

The at least one neural network may be generated based on the plurality of images. The at least one neural network may be specific to the plurality of images. For example, generating the at least one neural network may be performed each time a new plurality of images is generated and/or accessed. The at least one neural network may be trained such that different planes (e.g., foreground, background) may be separated into different pictures. The at least one neural network may be trained such that information missing in a pixel in one image (e.g., of the plurality of images) may be reconstructed based on pixels in another image of the plurality of images. For example, the at least one neural network may be trained such that pixels blocked by an obstruction in one image (e.g., of the plurality of images) may be reconstructed based on pixels in another image of the plurality of images. For example, a pixel that is obstructed in the one image by an object may be reconstructed to show the background behind the obstruction.

Generating the at least one neural network may comprise training the at least one neural network based on stochastic gradient descent. Generating the at least one neural network may comprise optimizing a photometric reconstruction loss. The at least one neural network may be trained to separate a foreground feature from background in the plurality of images. The at least one neural network may comprise a first neural field flow network representing motion of at least one object in a first plane in the three-dimensional space. The at least one neural network may comprise a second neural field flow network representing motion of at least one object in a second plane in the three-dimensional space. Generating the at least one neural network may comprise generating an alpha map indicating locations of pixels of a feature (e.g., foreground feature) in the image (e.g., one or more of an obstruction or a reflection in the plurality of images). The at least one neural network may comprise at least one neural spline field model of flow. The neural spline field model may comprise a continuous flow representation based on fitting a polynomial function to the spline control points.

The at least one neural network may comprise one or more layers (e.g., a neural network for multiple layers, or a separate neural network for each layer). The one or more layers may comprise an obstruction layer, a transmission layer, and/or a combination thereof. Generating the at least one neural network trained to map input image coordinates to vectors of the spline control points may comprise generating data representing a first neural field flow for a first two-dimensional plane object at a first location in three-dimensional space in the cameral model. Generating the at least one neural network trained to map input image coordinates to vectors of the spline control points may comprise training the first neural field flow based on using the first neural field flow to generate an approximate image and minimizing a difference between the approximate image an image of the plurality of images.

Generating the at least one neural network trained to map input image coordinates to vectors of the spline control points may comprise generating data representing a second neural field flow for a second two-dimensional plane object at a second location in three-dimensional space in the cameral model. The first location may be in between a location of the camera device (e.g., in the camera model) and the second location (e.g., or vice versa). Generating the at least one neural network trained to map input image coordinates to vectors of the spline control points may comprise training the second neural field flow based on using the second neural field flow to generate the approximate image and minimizing the difference between approximate image and the image of the plurality of images.

The at least one neural network may comprise at least one neural field based alpha map. The alpha map may comprise an actual alpha map. The alpha map may comprise an inverse alpha map. The alpha may indicate pixel locations of an object, obstruction, foreground, reflection, and/or the like.

At step 209, at least one reconstructed image may be generated. The at least one reconstructed image may be generated based on the camera model. The at least one reconstructed image may be generated based on the at least one neural network. Generating the at least one reconstructed image may comprise using the at least one neural network to interpolate a color value for a pixel based on more than one spline control point (e.g., multiple spline control points representing different time points in a sequence of time points) associated with the pixel. The at least one reconstructed image may comprise a neural field image. The at least one reconstructed image may comprise a first image representing a first plane of the three-dimensional space. The at least one reconstructed image may comprise a second image representing a second plane of the three-dimensional space. The first plane may represent an obstruction layer and the second plane may represent a transmission layer. The first plane may be located in between the second plane and the camera device in the three-dimensional space of the camera model. The reconstructed image may modify, remove, add, or a combination thereof one or more of an object or a plane from one of the plurality of images.

At step 211, storage of the at least one reconstructed image may be caused. The at least one reconstructed image may be caused to be stored on the camera device, on a network location remote from the storage device, in a memory of a device performing the method 200, and/or the like. Causing storage may comprise sending the at least one reconstructed image (e.g., via a network, via an internal route) to a memory, storage device, and/or the like. The at least one reconstructed image may be caused to be displayed to a user, such as on the camera device, via a user interface, and/or the like. The at least one reconstructed image may be stored on a server device. A user interface may allow users to access the at least one reconstructed image from the server. The user interface may allow users to select one or more of the plurality of images and request that a reconstructed image be generated.

### EXAMPLES

The following provide examples and illustrations for further understanding the present disclosure. This disclosure is not limited to the specific examples described below, and any aspect disclosed below may be understood to be generalizable (e.g., as described above, or otherwise understood by those of ordinary skill in the art) or otherwise understood as separable from the other features with which it is disclosed. Any aspect below may be combined with any aspect and/or feature described above or shown in the figures.

### Neural Spline Fields for Burst Photography

The present disclosure provides a neural spline field model of optical flow. Also provided herein is a full two-layer projective model of burst photography, its loss functions, training procedure, and data collection pipeline.

### Neural Spline Fields.

Motivation. To recover a latent image, existing burst photography methods align and merge [11] pixels in the captured image sequence. Disregarding regions of the scene that spontaneously change—e.g., blinking lights or digital screens—pixel differences between images can be de-composed into the products of scene motion, illuminant motion, camera rotation, and depth parallax. Separating these sources of motion has been a long-standing challenge in vision [62,63] as this is a fundamentally ill-conditioned problem; in typical settings, scene and camera motion are geometrically equivalent [22]. One response to this problem is to disregard effects other than camera motion, which can yield high-quality motion estimates for static, mostly-lambertian scenes [9, 26,71]. This can be represented as

$$I ( u , v , t ) = [ R , G , B ] = f ( {ππ}_{t}^{- 1} ( u , v ) ) , \qquad ( 1 )$$

where I(u,v,t) is a frame from the burst stack captured at time t and sampled at image coordinates u,v∈[0,1]. Operators π and π_t perform 3D reprojection on these coordinates to transform them from time t to the coordinates of a reference image model f(u,v)→[R,G,B]. To account for other sources of motion, layer separation approaches such as [28, 51] estimate a generic flow model Δu,Δv=g(u,v,t) to re-sample the image model

$$I ( u , v , t ) = f ( u + Δ u , v + Δ v ) , \qquad ( 2 )$$

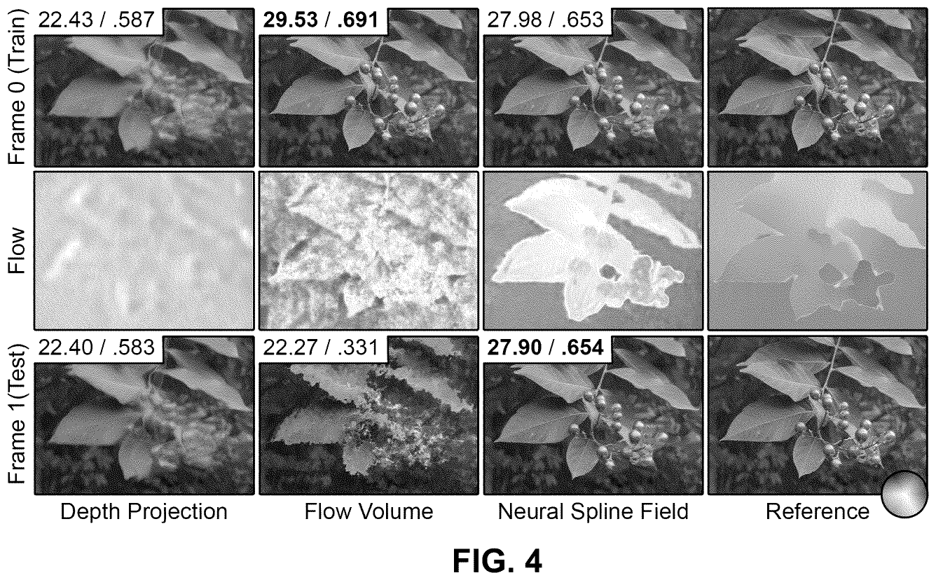

However, this parametrization introduces an overfitting risk, the consequences of which are illustrated in FIG. 4, as g(u,v,t) and f(u,v) can now act as a generic video encoder [39]. To combat this, methods often employ a form of gradient penalty such as total variation loss [51]. That is

$${ℒ}_{TVFlow} = \sum {‖ {J}_{g} ( u , v , t ) ‖}_{1} , \qquad ( 3 )$$

where J_g (u,v,t) is the Jacobian of the flow model. During training, this can prove computationally expensive, however, as now each sample requires its local neighborhood to be evaluated to numerically estimate the Jacobian, or a second gradient pass over the model. In both cases, a large number of operations are spent to limit the reconstruction of high frequency spatial and temporal content.

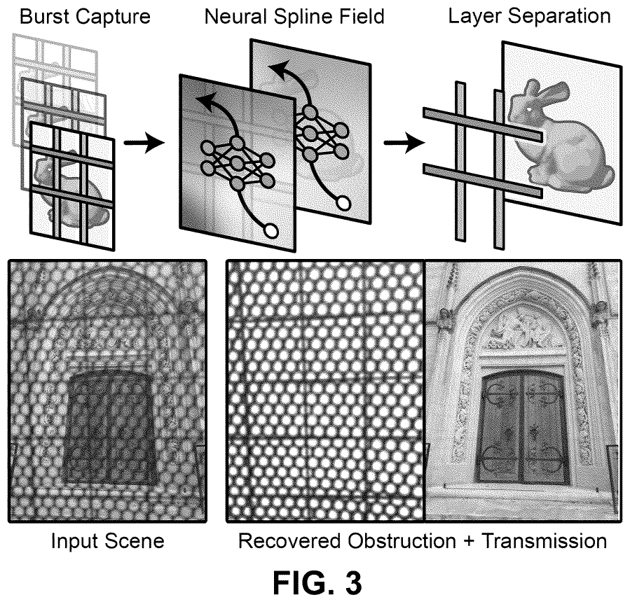

FIG. 3 shows a schematic demonstrating fitting an exemplary two-layer neural spline field model to a stack of images in order to be able to directly estimate and separate even severe, out-of-focus obstructions to recover hidden scene content.

FIG. 4 shows exemplary image and flow estimates for different representations of a short video sequence of a swinging branch; PSNR/SSIM values inset top-left. Depth projection alone is unable to represent both parallax and scene motion, mixing reconstructed content, and an un-regularized 3D flow volume g(u, v, t) trivially overfits to the sequence. With an identical network, spatial encoding, loss function, and training procedure as g(u, v, t), our neural spline field S(t;P=h(u, v)) produces temporally consistent flow estimates well-correlated with a conventional optical flow reference.

Formulation. A neural spline field (NSF) model of flow is proposed herein, a learned spatio-temporal spline [69] representation which provides strong controls on reconstruction directly through its parametrization. This model splits flow evaluation into two components

$$Δ u , Δ v = g ( u , v , t ) = S ( t ; P = h ( u , v ) ) . \qquad ( 4 )$$

Here h(u,v) is the NSF, a network which maps image coordinates to a set of spline control points P. Then, to estimate flow for a frame at time t in the burst stack, we evaluate the spline at S(t,P). We select a cubic Hermite spline

$$S ( t , P ) = ( 2 {t}_{r}^{3} - 3 {t}_{r}^{2} + 1 ) {P}_{⌊ {t}_{s} ⌋} + ( - 2 {t}_{r}^{3} + 3 {t}_{r}^{2} ) {P}_{⌊ {t}_{s} ⌋ + 1} + ( {t}_{r}^{3} - 2 {t}_{r}^{2} + {t}_{r} ) ( {P}_{⌊ {t}_{s} ⌋} - {P}_{⌊ {t}_{s} ⌋ - 1} ) \text{} / 2 + ( {t}_{r}^{3} - {t}_{r}^{2} + {t}_{r} ) ( {P}_{⌊ {t}_{s} ⌋ + 1} - {P}_{⌊ {t}_{s} ⌋ - 1} ) / 2 {t}_{r} = {t}_{s} - ⌊ {t}_{s} ⌋ , {t}_{s} = t \cdot \vert P \vert , \qquad ( 5 )$$

as it guarantees continuity in time with respect to its zeroth, first, and second derivatives and allows for fast local evaluation—in contrast to Bézier curves [9] which require recursive calculations. It is emphasized that the use of splines in graphics problems is extensive [13], and that there are many alternate candidate functions for S(t,P). For example, if the motion is expected to be a straight line, a piece-wise linear spline with |P|=2 control points would insure this constraint is satisfied irrespective of the outputs of h(u,v).

Where the choice of S(t,P) and |P| determines the temporal behavior of flow, h(u,v) controls its spatial properties. While the present method, in principle, is not restricted to a specific spatial encoding function, we adopt the multi-resolution hash encoding γ(u,v) presented in Müller et al. [49]

$$h ( u , v ) = h ( γ ( u , v ; p a r a m {s}_{γ} ) ; θ ) p a r a m {s}_{γ} = \{ {B}^{γ} , {S}^{γ} , {L}^{γ} , {F}^{γ} , {T}^{γ} \} , \qquad ( 6 )$$

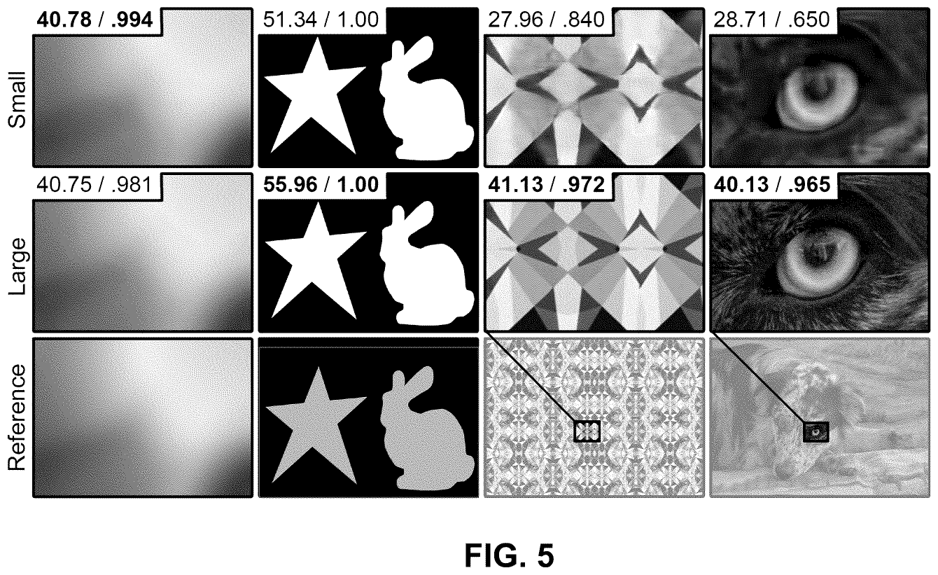

as it allows for fast training and strong spatial controls given by its encoding parameters paramsγ: base grid resolution Bγ, per level scale factor Sγ, number of grid levels Lγ, feature dimension Fγ, and backing hash table size Tγ. Here, h(γ(u,v);θ) is a multi-layer perceptron (MLP) [24] with learned weights θ. Illustrated in FIG. 5 with an image fitting example, the number of grid levels L^{γ}—which, with a fixed S^{γ}, sets the maximum grid resolution—provides controls on the maximum “spatial complexity” of the output while still permitting accurate reconstruction of image edges.

FIG. 5 shows exemplary image fitting results for coordinate networks with Small (Lγ=8) and Large (Lγ=16) multi-resolution hash encodings and identical other parameters; PSNR/SSIM values inset top-left. Unlike a traditional band-limited representation, the Small resolution network is able to fit both low-frequency smooth gradients and sharp edge mask images, but fails to fit a high density of either. This makes it a promising candidate representation for scene flow and alpha mattes which are comprised of smooth gradients and a limited number of object edges.

### Projective Model of Burst Photography

Motivation. With a flow model g(u,v,t), and a canonical image representation f(u,v), in hand, we theoretically have all the components needed to model an arbitrary image sequence [28,51]. However, handheld burst photography does not produce arbitrary image sequences; it has well-studied photometric and geometric properties [9,10,21,65]. This, in combination with the abundance of physical metadata such as gyroscope values and calibrated intrinsics available on modern smartphone devices [9], provides strong support for a physical model of image formation.

Formulation. A forward model similar to traditional multi-planar imaging is adopted [22]. It is noted that this departs from existing work [9, 10], which employs a backward projection camera model—“splatting” points from a canonical representation to locations in the burst stack. A multi-plane imaging model allows for both simple composition of multiple layers along a ray—a task for which backward projection is not well suited—and fast calculation of ray intersections without the ray-marching needed by volumetric representations like NeRF [48].

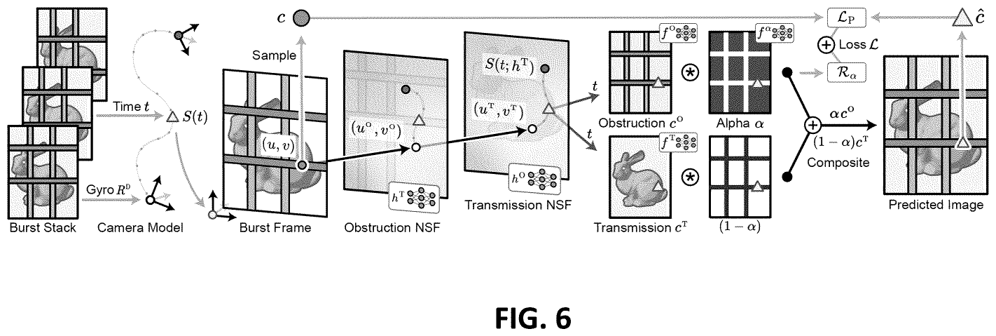

FIG. 6 is an exemplary model of an input image sequence as the alpha composition of a transmission and obstruction plane. Motion in the scene is expressed as the product of a rigid camera model, which produces global rotation and translation, and two neural spline field models, which produce local flow estimates for the two layers. Trained to minimize photometric loss, this model separates content to its respective layers.

For simplicity of notation, we outline this model for a single projected ray below. This process is also illustrated in FIG. 6. Let

$$c = {[ R , G , B ]}^{T} = I ( u , v , t ) \qquad ( 7 )$$

be a colored point sampled at time t in the burst stack at image coordinates u,v∈[0,1]. Note that these coordinates are relative to the camera pose at time t; for example (u,v)=(0,0), is always the bottom-left corner of the image. To project these points into world space we introduce camera translation T(t) and rotation R(t)models

$$T ( t ) = S ( t , {P}^{T} ) , R ( t ) = {R}^{D} ( t ) + {η}_{R} S ( t , {P}^{R} ) {P}_{i}^{T} = [ \begin{matrix}x \\ y \\ z\end{matrix} ] , {P}_{i}^{T} = [ \begin{matrix}0 & - {r}^{z} & {r}^{y} \\ {r}^{z} & 0 & - {r}^{x} \\ - {r}^{y} & {r}^{x} & 0\end{matrix} ] . \qquad ( 8 )$$

Here S(t,P) is the same cubic spline model from Eq. (4), evaluated element-wise over the channels of P. We note there are no coordinate networks employed in these models. Translation T(t) is learned from scratch, P^{T} initialized to all-zeroes. Rotation R(t) is learned as a small-angle approximation offset [26] to device rotations R^{D} (t)recorded by the phone's gyroscope—or alternatively, the identity matrix if such data is not available. With these two models, and calibrated intrinsic matrix K from the camera metadata, we now generate a ray with origin O and direction D as Ox Dx u

$$O = [ \begin{matrix}{O}_{x} \\ {O}_{y} \\ {O}_{z}\end{matrix} ] = T ( t ) , D = [ \begin{matrix}{D}_{x} \\ {D}_{x} \\ 1\end{matrix} ] = \frac{R ( t ) {K}^{- 1}}{{D}_{z}} [ \begin{matrix}u \\ v \\ 1\end{matrix} ] , \qquad ( 9 )$$

where D is normalized by its z component. We define our transmission and obstruction image planes as Π^{T} and Π^{O}, respectively. As XY translation of these planes conflicts with changes in the camera pose, we lock them to the z-axis at depth Π_{z} with canonical axes Πᵤ and Πᵥ. Thus, given ray direction D has a z-component of 1, we can calculate the ray-plane intersection as Q=O+(Π_{z}−O_{z})D and project to plane coordinates

$${u}^{Π} , {v}^{Π} 〈 Q , {Π}_{u} 〉 / ( {Π}_{z} - {O}_{z} ) , 〈 Q , {Π}_{u} 〉 / ( {Π}_{z} - {O}_{z} ) \qquad ( 10 )$$

scaled by ray length to preserve uniform spatial resolution. Let u^{T}, v^{T} and u^{O}, v^{O} be the intersection coordinates for the transmission and obstruction plane, respectively. The layers are alpha composited along the ray as

$$\hat{c} = ( 1 - α ) {c}^{T} + α {c}^{O} {c}^{T} = {f}^{T} ( {u}^{T} + Δ {u}^{T} , {v}^{T} + Δ {v}^{T} ) , Δ {u}^{T} , Δ {v}^{T} = S ( t , {h}^{T} ( {u}^{T} , {v}^{T} ) ) {c}^{O} = {f}^{O} ( {u}^{O} + Δ {u}^{O} , {v}^{O} + Δ {v}^{O} ) , Δ {u}^{O} , Δ {v}^{O} = S ( t , {h}^{O} ( {u}^{O} , {v}^{O} ) ) α = σ ( {τ}_{σ} {f}^{α} ( {u}^{O} + Δ {u}^{O} , C + Δ {v}^{O} ) ) , \qquad ( 11 )$$

where c\hat{ } is the composite color point, the weighted sum by α of the transmission color c^{T} obstruction color c^{O}. Each is the output of an image coordinate network f(u, v) sampled at points offset by flow from an NSF h(u, v). The sig-moid function σ=1/(1+e^{-x}) with temperature T_{σ} controls the transition between opaque α=1 and partially translucent α=0.5 obstructions. This proves particularly helpful for learning hard occluders—e.g., a fence—where large τσ creates a steep transition between α=0 and α=1, which discourages f^{α}(u, v) from mixing content between layers.

### Training Procedure

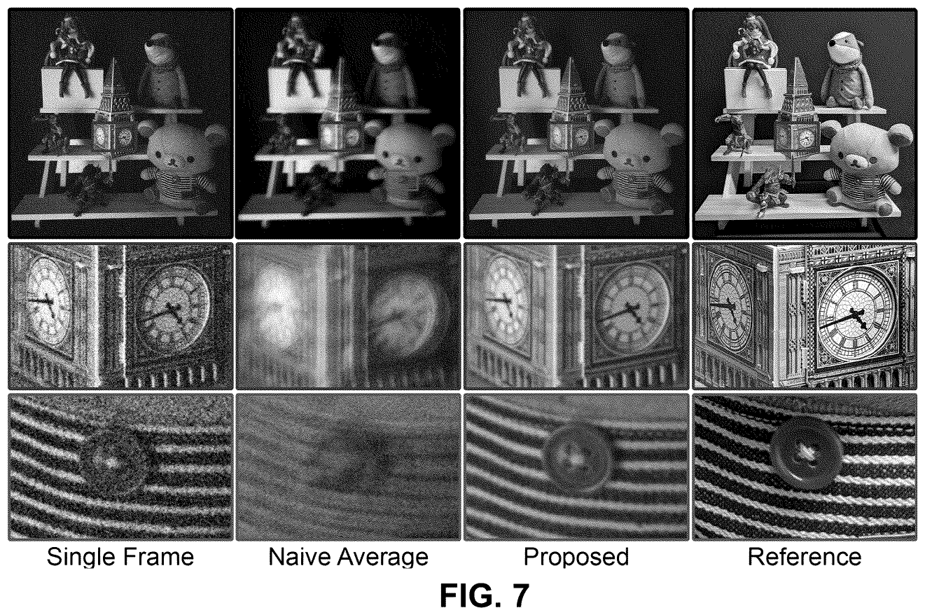

Losses. Given all the components of our model are fully differentiable, we train them end-to-end via stochastic gradient descent. The loss function L is defined as

$$ℒ = {ℒ}_{P} + {η}_{α} {ℛ}_{α} {ℒ}_{P} = \vert ( c - \hat{c} ) / ( sg ( c ) + ϵ ) \vert , {ℛ}_{α} = \vert α \vert , \qquad ( 12 )$$

where [symbol] _{P} is a relative photometric reconstruction loss [9, 47], and sg is the stop-gradient operator. Shown in FIG. 7, when combined with linear RAW input data this loss proves robust in noisy imaging settings [47], appropriate for in-the-wild scene reconstruction with unknown lighting conditions. Regularization term [symbol] _{α} with weight η_{α} penalizes content in the obstruction layer, discouraging it from duplicating features from the transmission layer.

FIG. 7 shows exemplary reconstruction results for noisy, low-light conditions; exposure time 1/30, ISO 5000. The proposed model is able to robustly merge frames into a denoised image representation.

Training. Given the high-dimensional problem of jointly solving for camera poses, image layers, and neural spline field flows, coarse-to-fine optimization was utilized in order to avoid low-quality local minima solutions. The multi-resolution hash encodings γ(u,v) input were masked into the image, alpha, and flow networks, activating higher resolution grids during later epochs of training:

$${γ}_{i} ( u , v ) = \{ \begin{matrix}{γ}_{i ( u , v )} & if i / \vert γ \vert < 0.4 + 0.6 ( sin\_epoch ) \\ 0 & if i / \vert γ \vert < 0.4 + 0.6 ( sin\_epoch )\end{matrix} \qquad ( 13 )$$

$$sin epoch = sin ( epoch / max epoch ) ,$$

This strategy results in less noise accumulated during early training as spurious high-resolution features do not need to be “unlearned” [9, 38] during later stages of refinement.

### Applications

Data Collection. To collect burst data the open-source Android camera capture tool Pani was modified to record continuous streams of RAW frames and sensor metadata. During capture, exposure and focus settings were locked to record a 42 frame, two-second “long-burst” of 12-megapixel im-ages, gyroscope measurements, and camera metadata. Data is captured from a set of Pixel 7, 7-Pro, and 8-Pro devices, with no notable differences in overall reconstruction quality or changes in the training procedure required. The networks are trained directly on Bayer RAW data and apply device color-correction and tone-mapping for visualization.

Implementation Details. During training, stochastic gradient descent is performed on [symbol] for batches of 2¹⁸ rays per step for 6000 steps with the Adam optimizer [29]. All networks use the multi-resolution hash encoding described in Eq. (5), implemented in tiny-cuda-nn [50]. Trained on a single Nvidia RTX 4090 GPU, the method takes approximately 3 minutes to fit a full 42-frame image sequence. All networks have a base resolution B^{γ}=4, and scale factor S^{γ}=1.61, but while flow networks h^{T} and O are parameterized with a low number of grid levels L^{γ}=8, networks h^{T} and O are parameterized with a low number of grid levels L^{γ}=8, networks which represent high frequency content have L^{γ}=12 or L^{γ}=16 levels. These settings are task-specific, and full implementation details and results for short (4-8 frame) image bursts are included below.

Occlusion Removal. Initializing the obstruction plane closer to the camera than the transmission plane, that is

$${Π}_{z}^{O} < {Π}_{z}^{T} ,$$

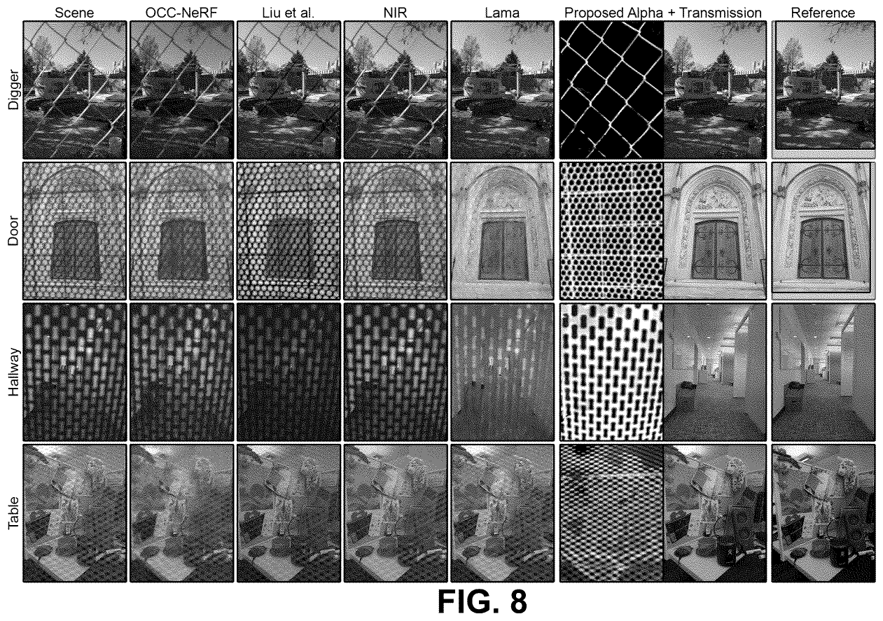

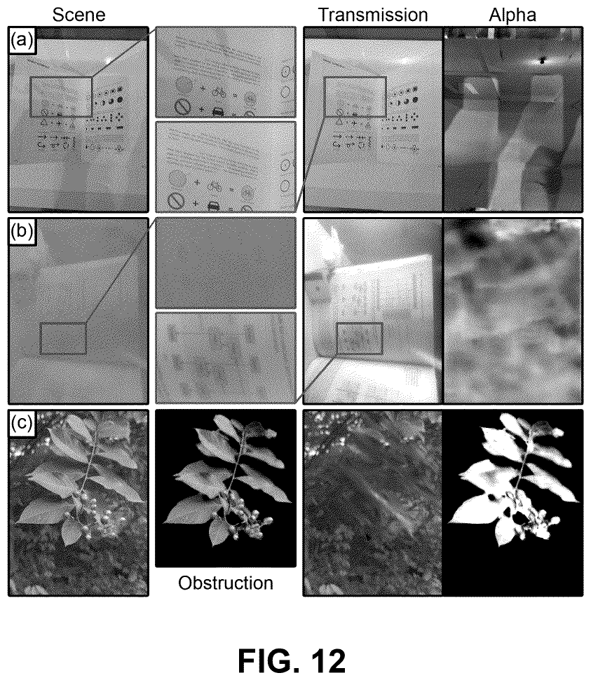

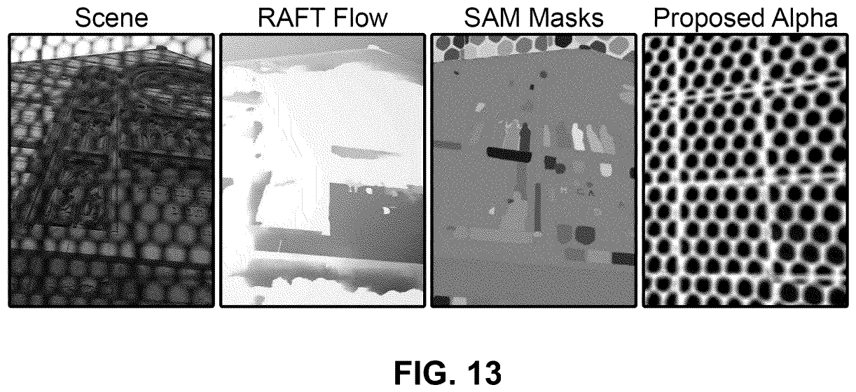

we find that the f^{O}(u, v) naturally reconstructs foreground content in the scene. Given a scene with content hidden behind a foreground occluder—e.g., imaging through a fence-occlusion removal can then be performed with the proposed method by setting α=0. Referring now to FIG. 8, results are reported for a set of captures collected with reference views using a tripod-mounted occluder. FIG. 8 shows exemplary occlusion removal results and estimated alpha maps for a set of captures with reference views; comparisons to single image, multi-view, and NeRF fitting approaches. The inventors compare here to the multiview plus learning method presented in Liu et al. [43], the neural radiance field approach OCC-NeRF [72], the flow+homography neural image model NIR [51], and the single image inpainting method Lama [58] as these methods demonstrate a broad range of techniques for occlusion detection and removal with varying assumptions on camera motion. In this small baseline burst photography setting, existing multi-view methods fail to achieve meaningful occlusion removal; as the occluder maintains a high level of self-overlap for the whole image sequence. While the single-image method, Lama is able to in-paint occluded regions based on un-occluded content, it cannot faithfully recover lost details such as the carvings in the Door scene. Furthermore, Lama does not produce an alpha matte, and rather requires a hand-annotated mask as input. Referring now to FIG. 13, even otherwise robust mask segmentation networks such as the Segment Anything Model (SAM) [30] fail to correctly detect complex occluders. FIG. 13 shows an exemplary learned flow estimator RAFT and segmentation model SAM struggle to produce meaningful outputs for a small-motion scene with an out-of-focus occluder. SAM successfully segments some objects behind the occluder (e.g., the statues on the building) but does not correctly segment the occluder itself. In contrast, the present approach distills information from all input frames to accurately recover temporarily occluded content, and jointly produces a high-quality alpha matte. In FIG. 12 additional layer separation results for real in-the-wild scenes with complex occluders are presented, which demonstrate the versatility of the obstruction image model f^{O} (u,v). FIG. 12 shows exemplary layer separation results for additional example applications: row (a) shows shadow removal, row (b) shows image dehazing, and row (c) shows video motion segmentation.

### Reflection Removal.

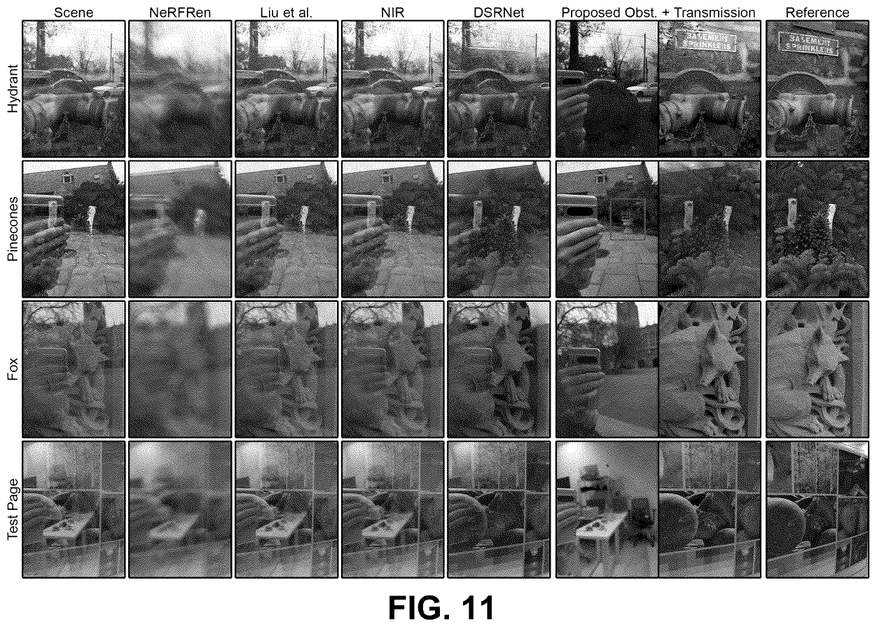

Referring now to FIG. 11, it is shown how by flipping the plane depths

$${Π}_{z}^{O} > {Π}_{z}^{T} ,$$

the model is also able to separate reflected from transmitted content. FIG. 11 shows exemplary reflection removal results and estimated alpha maps for a set of captures with reference views; comparisons to single image, multi-view, and NeRF fitting approaches. Here, a comparison is again made to Liu et al. [43] and NIR [51], as well as the reflection-specific neural radiance approach NeRFReN [19] and single-image reflection removal network DSR-Net [25]. Similarly to occlusion removal, it was observed that given small-baseline inputs the multi-view methods fail to achieve meaningful layer separation, and NeRFRen struggles to converge on a sharp reconstruction. Only DSR-Net is able to suppress even small parts of the reflection such as the car in the Hydrant scene. In contrast, the proposed method not only estimates nearly reflection-free transmission layers, but is also able to recover hidden content—such as the flowerpot highlighted in Pinecones—in the reflection layer.

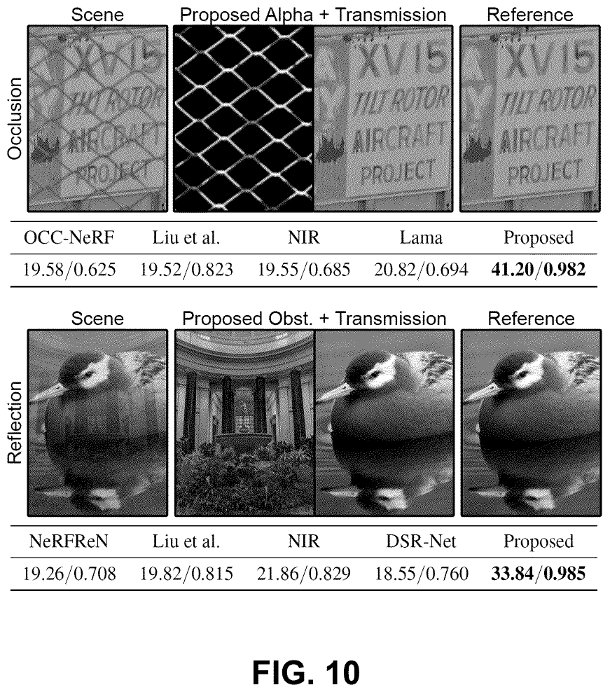

Synthetic Validation. Given in-the-wild captures do not have perfectly aligned reference images, to further validate our method we construct a set of rendered scenes with paired ground truth data. Referring now to FIG. 10, quantitative and qualitative results are shown which align with findings from real-world captures, with significant PSNR and SSIM improvements across all scenes. FIG. 10 shows exemplary qualitative and quantitative obstruction removal results for a set of synthetic scenes with paired ground truth, camera motion simulated from real measured hand shake data [10]. Evaluation metrics are formatted as PSNR/SSIM.

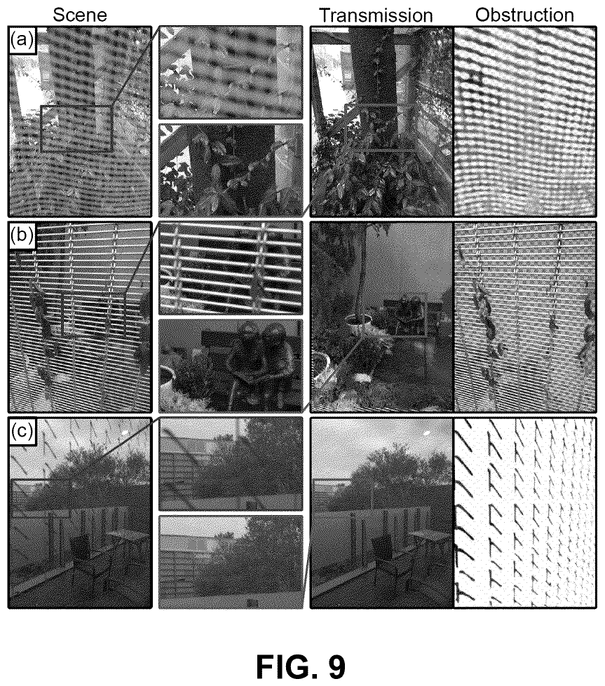

Image Enhancement through Layer Separation. In addition to occlusion and reflection removal, a wide range of other computational photography applications can be viewed through the lens of layer separation. Referring now to FIG. 9, several example tasks are showcased, including shadow removal, image dehazing, and video motion segmentation. FIG. 9 shows exemplary layer separation results in unique real-world cases enabled by our generalizable two-layer image model: row (a) shows an orange planter, row (b) shows a fenced garden, and row (c) shows stickers on balcony glass. The key relationship between all these tasks is that the two effects undergo different motion models—e.g., photographer-cast shadows move with the cellphone, while the paper target stays static. By grouping color content with its respective motion model, f^{T}(u, v) with h^{T}(u, v) and f^{O}(u, v) with h^{O}(u, v), just as in the occlusion case, we can remove the effect by removing its image plane. FIG. 9, row (c), which fits our two-layer model for an image sequence of a moving tree branch, also highlights that our method does not rely solely on camera motion. Scene motion itself can also be used as a mechanism for layer separation in image bursts, similar to approaches in video masking [28, 44].

### Implementation Details

### Data Acquisition.

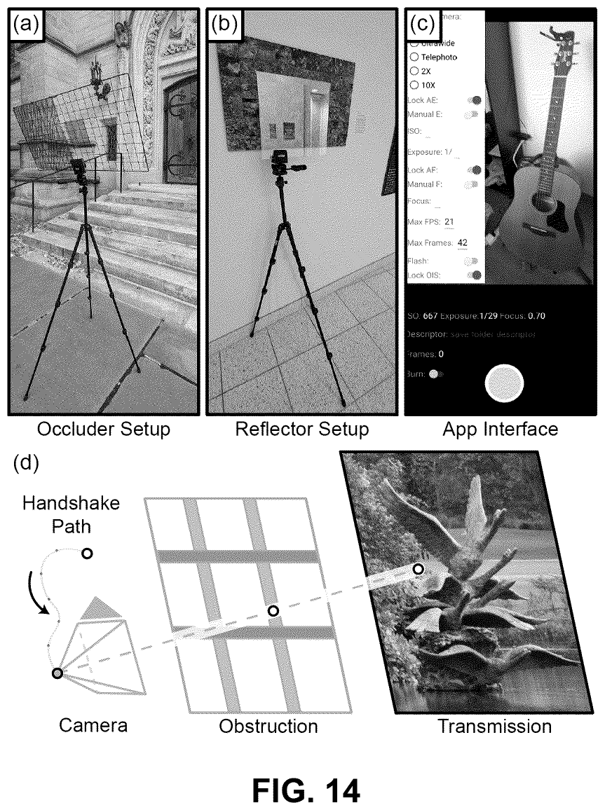

Referring now to FIG. 14, in order to acquire paired obstructed and unobstructed captures, two tripod-mounted rigs were constructed, illustrated in FIG. 14 rows (a-b). FIG. 14 shows in panel (a) a tripod-mounted occluder setup for capturing paired occlusion removal data; panel (b) shows a tripod-mounted reflector setup for capturing paired reflection removal data; panel (c) shows an exemplary capture application interface with the extended settings menu. Panels (d) and (e) show an example 3D scene with simulated occluder, camera frustum highlighted in orange.

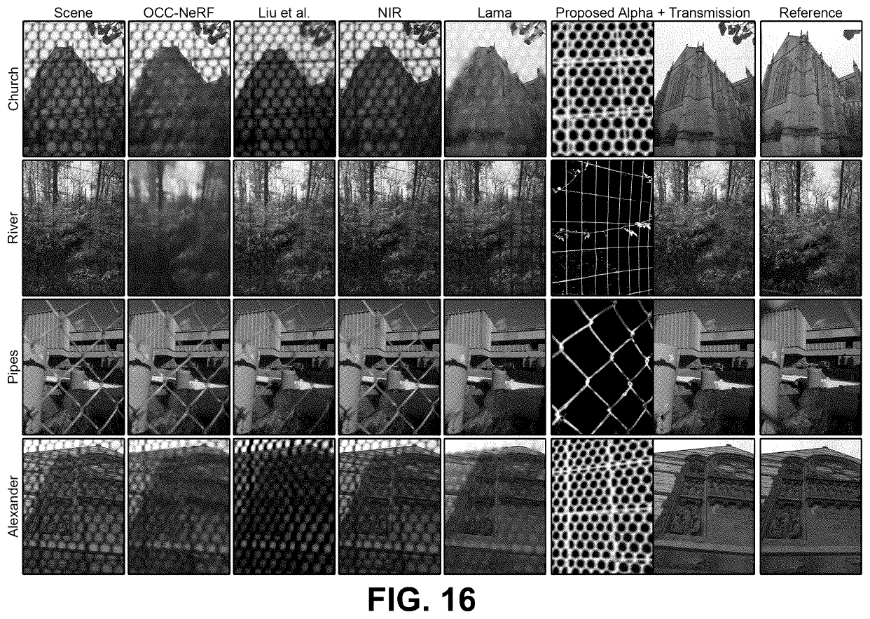

By first capturing a still of the scene without the obstruction, before rotating the tripod into position to capture a 42-frame obstructed long-burst [10] of 12-megapixel RAW frames. As the rig is only used to hold the obstruction—i.e., the smartphone is not attached to it—it does not affect natural hand motion during capture. For accessible natural occluders, such as the fences in FIG. 16, we acquire reference views by positioning the phone at a gap in the occluder—though this sometimes cannot perfectly remove the occluder as in the case of FIG. 16 Pipes. FIG. 16 shows exemplary occlusion removal results and estimated alpha maps for a set of captures with reference views, with comparisons to single image, multi-view, and NeRF fitting approaches.

Data was collected with the modified Pani capture app, illustrated in FIG. 14 row (c), built on the Android cam-era2 API. During capture, metadata such as camera intrinsics, exposure settings, channel color correction gains, tonemap curves, and other image processing and camera information was also recorded during capture. Gyroscope and accelerometer measurements were streamed from on-board sensors as ≈100 Hz, though we find accelerometer values to be highly unreliable for motion on the scale of natural hand tremor, and so disregard these measurements for this work. Minimal processing was applied to the recorded 10-bit Bayer RAW frames—only correcting for lens shading and BGGR color channel gains—before splitting them into a 3-plane RGB color volume. No further demosaicing was performed on this volume, as these processes correlate local signal values, and instead input it directly into our model for scene fitting. For visualization, we apply the default color correction matrix and tone-curve supplied in the capture metadata.

Synthetic Data Generation. Capturing aligned ground-truth data for obstruction removal is a long-standing problem in the field [64], greatly exacerbated by the requirement in our setting of a sequence of unstabilized frames with its base frame aligned to an unobstructed image. Thus, to help validate our method, we turn to synthetic captures created through image reprojection. The inventors used 61-megapixel digital camera (Sony A7RIV) captures to simulate the transmission layer, and either hand-segmented occluders or a second 61-megapixel “reflection” image to simulate the obstruction. These are simulated as 3D planes in space at depths

$${Π}_{z}^{O} and {Π}_{z}^{T} respectively - {Π}_{z}^{O} < {Π}_{z}^{T} for occluders and {Π}_{z}^{O} > {Π}_{z}^{T}$$

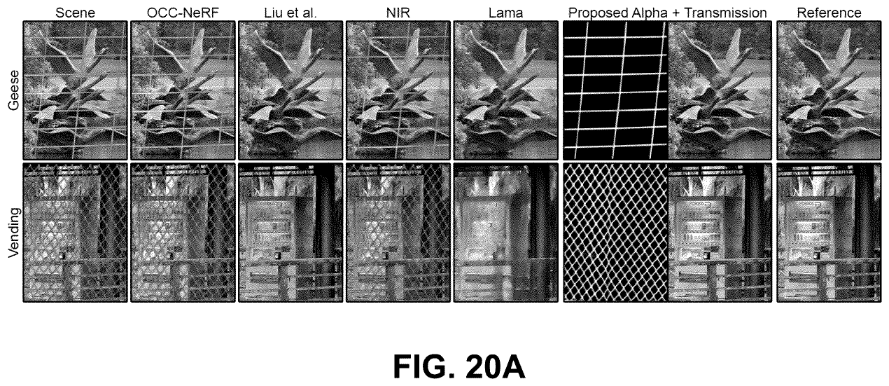

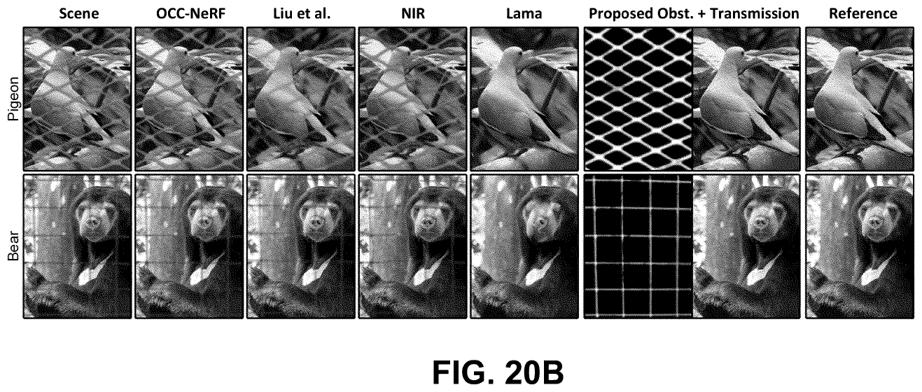

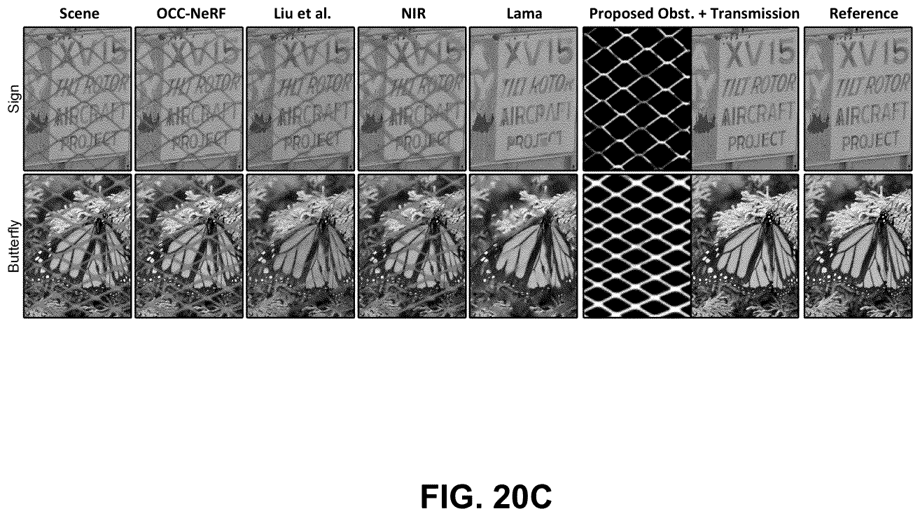

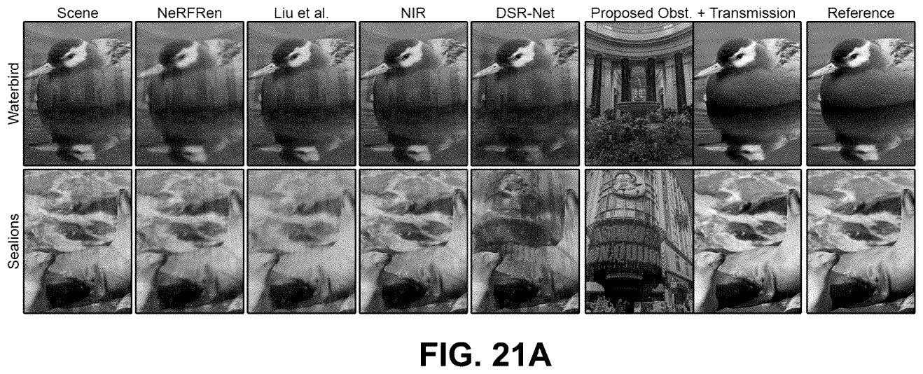

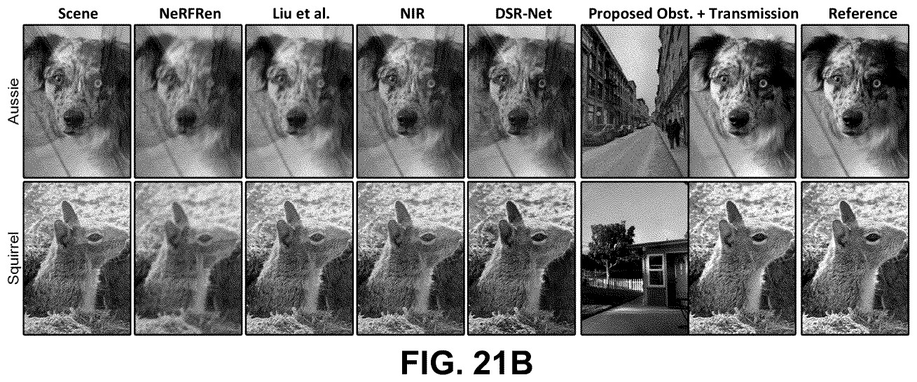

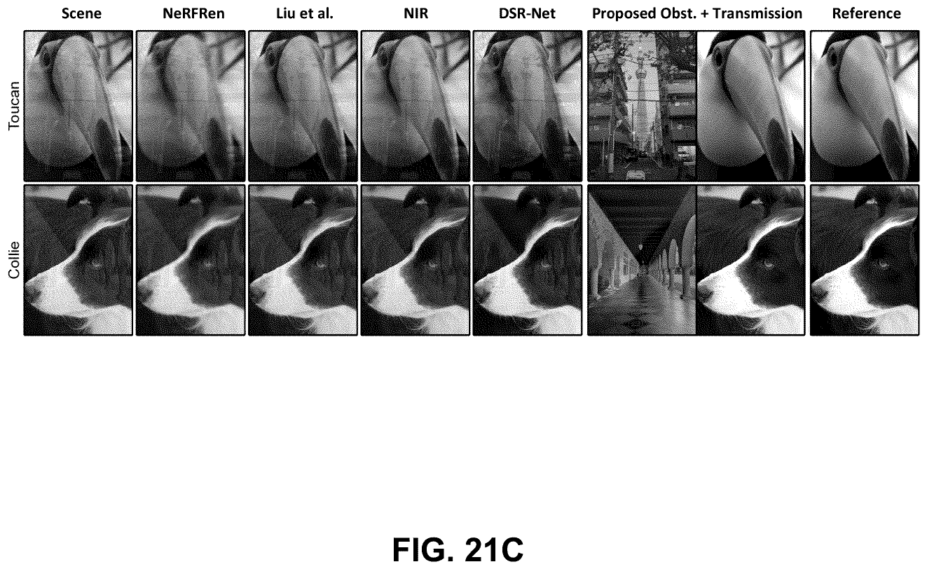

for reflectors—and apply a random tilt to the planes with angle θ∈[−20°, 20° ]. To generate realistic camera motion, we record samples of natural hand tremor with a pose-capture application built on the Apple ARKit library [10]. We then apply this motion path to a projective camera model, re-sample the image planes, and alpha-composite the outputs to produce the simulated burst stack. This data does not capture all the imaging effects present in real burst photography—e.g., lens distortion, scene deformation, motion blur, chromatic aberrations, or sensor and microlens defects—and use it as a tool for validating correct layer separation rather than a benchmark for overall performance. Reconstruction results for these simulated bursts are shown in FIGS. 20A-C and FIGS. 21A-C. FIGS. 20A-C shows exemplary qualitative and quantitative occlusion removal results for a set of 3D rendered scenes with paired ground truth. Evaluation metrics were formatted as PSNR/SSIM. FIGS. 21A-C shows exemplary qualitative and quantitative reflection removal results for a set of 3D rendered scenes with paired ground truth. Evaluation metrics were formatted as PSNR/SSIM.

Implementation Details. While the overarching model structure is held constant between all applications—identical projection, image generation, and flow models for all tasks—elements such as the neural spline field h(u,v) encoding parameters params_γ can be tuned for specific tasks:

$$h ( u , v ) = h ( γ ( u , v ; p a r a m {s}_{γ} ) ; θ ) p a r a m {s}_{γ} = \{ {B}^{γ} , {S}^{γ} , {L}^{γ} , {F}^{γ} , {T}^{γ} \} , \qquad ( 14 )$$

By manipulating the parameters of Eq. 14 as defined in Table 1 we construct four different “sizes” of network encodings: Tiny, Small, Medium, and Large. Image fitting results in FIG. 4 illustrate what scale of features each of these configurations is able to reconstruct, with larger encoding reconstructing denser and higher-frequency content. Then, assembling together multiple image and flow networks with varying encoding sizes as defined in Table 1, we are able to leverage this feature scale control for layer separation tasks such as occlusion, reflection, or shadow removal.

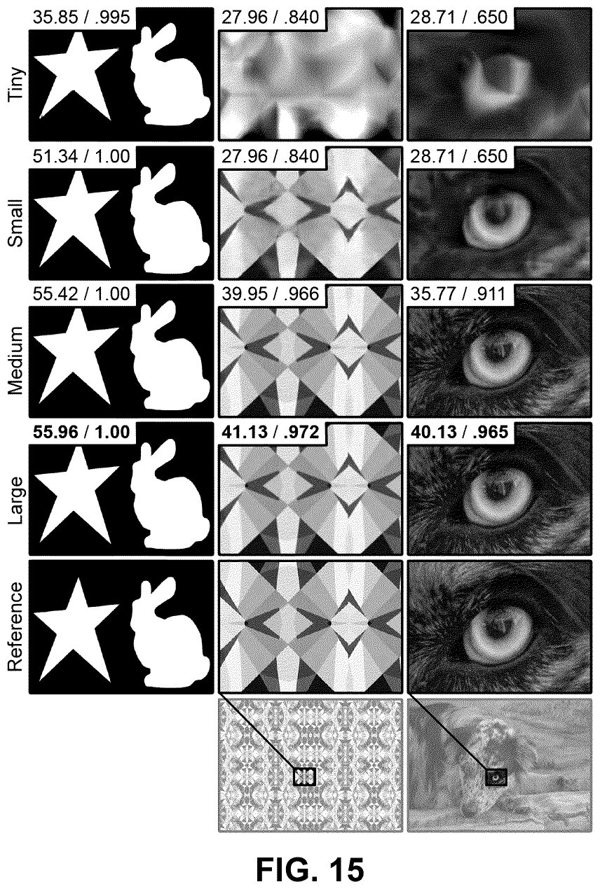

FIG. 15 shows exemplary image fitting results for network encoding configurations as described in Table. 1, other training and network parameters held constant: 5-layer MLP coordinate networks, hidden dimension 64, ReLU activations. PSNR/SSIM values inset top-left.

For tasks such as video segmentation, it is important that both the transmission layer and obstruction layer are able to represent high-resolution images, as the purpose here is to divide and compress video content into two canonical views, alpha matte, and optical flow. Hence for the video segmentation task in Table 1 both layers have Large network encodings. Conversely, for a task such as shadow removal we want to minimize the amount of color and alpha information the shadow obstruction layer is able to represent—as shadows, like the mask example in FIG. 4, are comprised of mostly low-resolution image features. Correspondingly, the shadow removal task in Table 1 has a Tiny image color encoding and only a Medium size alpha encoding. These parameters are kept constant between all tested scenes for clarity of presentation, however we emphasize that these model configurations are not prescriptive; all neural scene fitting approaches [48] have per-scene optimal parameters. Given the relatively fast training speed of our approach, approximately 3 mins on a single Nvidia RTX 4090 GPU, in settings where data acquisition is costly—e.g., scientific imaging settings such as microscopy—it may even be tractable to sweep model parameters to optimally reconstruct each individual capture.

TABLE 1

| Size | base B^{γ} | scale S^{γ} | levels L^{γ} | feat. F^{γ} | table T^{γ} |
|---|---|---|---|---|---|
| Tiny (T) | 4 | 1.61 | 6 | 4 | 12 |
| Small (S) | 4 | 1.61 | 8 | 4 | 14 |
| Medium (M) | 4 | 1.61 | 12 | 4 | 16 |
| Large (L) | 4 | 1.61 | 16 | 4 | 18 |

Table 1 shows multi-resolution hash-table encoding parameters for different “sizes” of network, with larger encodings intended to fit higher-resolution data. Note that only the number of grid levels L^{γ} is varied, and the backing table size T^{γ} matched accordingly to avoid hash collisions. The base grid resolution B^{γ}, grid per-level scale S^{γ}, and feature encoding size F^{γ} are kept constant.

TABLE 2

| | | | | | |
|---|---|---|---|---|---|
| flow h | \|h\| | rgb f | f^{α} | depth Π_{z} | ηα [symbol] |

occlusion removal:

| | | | | | | |
|---|---|---|---|---|---|---|
| Tr: | T | 11 | L | | 1.0 | 0.02 |
| Ob: | T | | M | M | 0.5 | |

reflection removal:

| | | | | | | |
|---|---|---|---|---|---|---|
| Tr: | T | 11 | L | | 1.0 | 0.0 |
| Ob: | T | 11 | T | L | 2.5 | |

video segmentation:

| | | | | | | |
|---|---|---|---|---|---|---|
| Tr: | S | 15 | L | | 1.0 | 0.002 |
| Ob: | S | 15 | L | M | 2.0 | |

shadow removal:

| | | | | | | |
|---|---|---|---|---|---|---|
| Tr: | T | 11 | L | | 1.0 | 0.0 |
| Ob: | T | 11 | T | M | 2.0 | |

dehazing:

| | | | | | | |
|---|---|---|---|---|---|---|
| Tr: | T | 11 | L | | 1.0 | 0.01 |
| Ob: | T | 11 | T | S | 0.5 | |

image fusion:

| | | | | | |
|---|---|---|---|---|---|
| Tr: | S | 31 | L | 1.0 | 0.0 |

Table 2 shows network encoding, flow, and loss configurations used for several layer-separation applications, separated into rows individually defining transmission Tr and obstruction Ob layers. Encoding parameters are defined by the corresponding (T,S,M,L) row of Table 1. Flow size |h| indicates the number of spline control points used for interpolation of the corresponding neural spline field S(t, h(u, v))

### Additional Reconstruction Results

Additional quantitative and qualitative obstruction removal results are provided herein, comparing our proposed model against a range of multi-view and single-image methods. Discussion of challenging imaging settings and potential directions of future work to address them are also provided.

Occlusion Removal. A set of additional occlusion removal results is included in FIG. 5 with natural environmental occluders such as fences and grates. Results were evaluated against the multi-image learning-based obstruction removal method Liu et al. [43], the NeRF-based method OCC-NeRF [72], the flow plus homography neural image representation NIR [51], and the single image inpainting approach Lama [58]- to which we provide hand-drawn masks of the occlusion. It was found that, as observed in the main text, the multi-image methods struggle to remove significant parts of the obstruction. Though in some scenes, the multi-image baselines are able to decrease the opacity of the occluder to reveal details behind it. Nevertheless, in all cases the obstruction is still clearly visible after applying each baseline. Given the small camera baseline setting of our input data, the volumetric OCC-NeRF approach struggles to converge on a cohesive 3D scene representation, producing blurred or otherwise inconsistent image reconstructions—as is the case for the Church scene. It was found that the homography-based NIR method also struggles in this small baseline setting, often identifying the entire scene as the canonical view rather than partly obstructed. Given hand annotated masks, single image methods such as DALL-E and Lama [58] can successfully inpaint sparse occluders such as the fence in the Pipes scene, but struggle to recover content behind dense occluders such as in Alexander and Church in FIG. 16. As they have no way to aggregate content between frames, they “recover” hidden content from visual priors on the scene, which may not be reliable when the scene is severely occluded.

In contrast, the presently disclosed method automatically distills a high-quality alpha matte for the obstruction and reconstructs the underlying transmission layer using information from multiple views. This mask is of similar quality regardless of whether the scene is obstructed by a dense occluder or a sparse occluder, so long as there is sufficient parallax between the two layers. The depth-separation properties of our alpha estimation are showcased in the River example, where the obstruction layer isolated not only the grid of the fence, but also the branches and leaves weaved through the fence. The present method reconstructs the transmitted layer behind the occlusion with favorable results compared to all baseline methods.

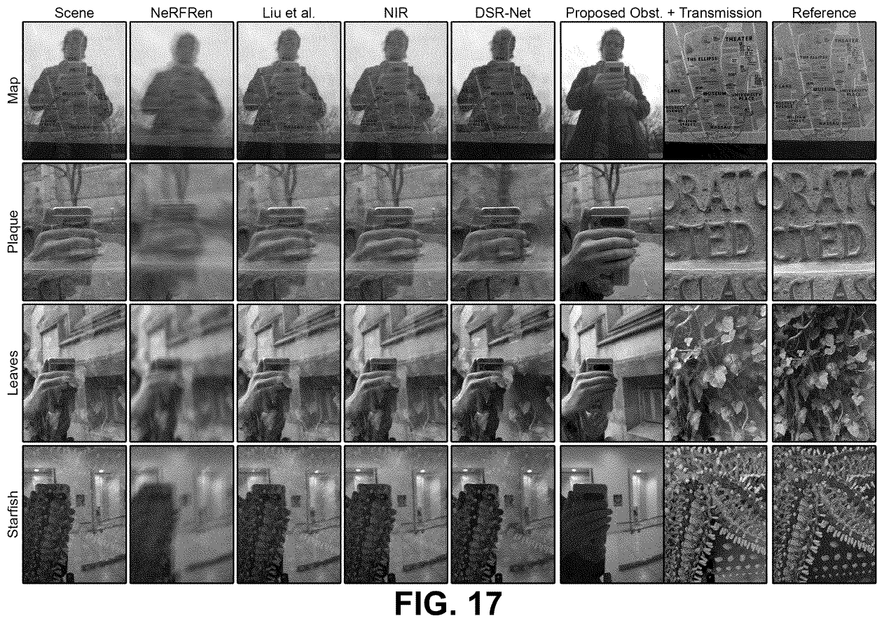

Reflection Removal. For reflection removal, we compare with the reflection-aware NeRF-based method NeR-FReN [19] in addition to NIR [51], Liu et al. [43], and the single-image reflection removal method DSRNet [25]. Reflection removal results are shown in FIG. 17. FIG. 17 shows exemplary reflection removal results and estimated alpha maps for a set of captures with reference views, with comparisons to single image, multi-view, and NeRF fitting approaches. Results were observed with a similar trend to those in the obstruction removal task. The volumetric method NeRFReN struggles to reconstruct a high-fidelity scene representation, as Liu et al. and NIR also struggle with the small baseline of the camera motion. The single-image method DSRNet performs best among the baselines, as it has no priors on image motion. However, without the ability to draw information from multiple views, DSRNet uses learned priors to disambiguate reflected and transmitted content. This appears not to be very effective for high opacity reflections, such as the Leaves example and the phone in the Plaque scene. The present method achieves the highest-quality reconstruction and layer separation among all methods tested, across all scenes, with our estimated obstruction revealing the detailed structure of the scene being reflected.

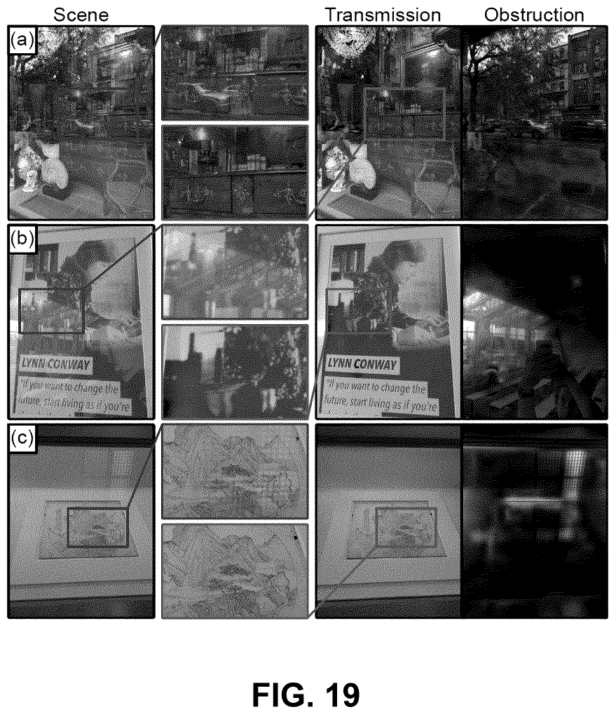

Referring now to FIG. 19, the model's performance on challenging, in-the-wild scenes is showcased where we do not have the ability to acquire reference views. FIG. 19 shows exemplary reflection removal results for challenging in-the-wild scenes: a storefront window is shown in row (a), a poster is shown in row (b), and a museum painting is shown in row (c).

Robust reflection removal was observed, matching the reconstruction quality observed for scenes acquired with our tripod setup.

TABLE 3

| Occlusion | OCC-NeRF | Liu et al. | NIR | Lama | Proposed |
|---|---|---|---|---|---|
| Geese | 19.49/0.578 | 32.24/0.970 | 20.89/0.696 | 21.96/0.760 | 41.80/0.986 |
| Pigeon | 18.60/0.691 | 15.17/0.725 | 18.74/0.691 | 21.55/0.753 | 40.33/0.965 |
| Sign | 24.34/0.870 | 24.11/0.952 | 22.84/0.905 | 28.57/0.932 | 48.63/0.994 |
| Vending | 18.05/0.550 | 15.10/0.754 | 17.96/0.625 | 17.42/0.591 | 39.62/0.981 |
| Bear | 23.72/0.696 | 26.32/0.930 | 23.28/0.746 | 23.84/0.815 | 40.88/0.980 |
| Butterfly | 17.67/0.674 | 15.43/0.828 | 18.25/0.750 | 17.89/0.722 | 39.53/0.980 |
| Reflection | NeRFReN | Liu et al. | NIR | DSR-Net | Proposed |
| Waterbird | 21.94/0.695 | 23.68/0.811 | 24.08/0.751 | 19.95/0.753 | 39.16/0.982 |
| Aussie | 18.88/0.561 | 18.09/0.634 | 20.54/0.665 | 19.56/0.738 | 30.90/0.971 |
| Toucan | 19.98/0.817 | 21.14/0.837 | 21.67/0.873 | 17.63/0.717 | 36.00/0.985 |
| Sealion | 20.28/0.811 | 11.45/0.726 | 22.36/0.899 | 13.27/0.657 | 32.31/0.993 |
| Squirrel | 17.15/0.431 | 23.55/0.950 | 22.04/0.789 | 19.05/0.860 | 33.34/0.988 |
| Collie | 18.60/0.706 | 22.34/0.862 | 22.08/0.801 | 21.96/0.847 | 32.98/0.978 |

Validation on Synthetic Scenes. Synthetic scenes were generated as described in Sec. A, and compare our obstruction removal results to the same baselines outlined in the previous sections, including: OCC-NeRF [72], NeRFReN [19], Liu et al. [43], NIR [51], Lama [58] and DSRNet [25]. Quantitative and qualitative results for occlusion removal and reflection removal are shown in FIG. 9 and FIG. 10 respectively. Also provided are NeRF-based methods with ground truth camera poses, which results in higher fidelity NeRF-based reconstruction than on real-world data. Overall, similar trends to the real-world examples were observed, with most multi-image based methods failing to remove the majority of the obstructions for the majority of scenes. This is with the exception of Liu et al. [43] for the Geese, Vending and Butterfly scenes in FIG. 20A and FIG. 20C, where it succeeds at removing a large portion of the fence occluders. Without wishing to be bound to theory, this is a strong indication that this method relies heavily on visual cues to identify the occluder (e.g., gray mostly-in-focus fences), and helps to explain its failure to identify and remove other categories of obstructions such as the black hexagonal grids in FIG. 16. Lama [58], when provided with a ground-truth occlusion mask, is able to reconstruct a relatively coherent transmission layer. However, upon closer inspection the results are missing details in the ground-truth transmission layer, such as the distorted text in Sign and missing beak of Pigeon in FIG. 20B and FIG. 20C. Both multi-image methods and DSRNet [25] were observed to fail to effectively remove reflections in FIGS. 21A-C, with DSRNet [25] accidentally enhancing the reflected content in the Sealions scene. These observations are supported by quantitative results, with the present method achieving the highest PSNR and SSIM across all scenes tested. It was observed that an average PSNR increase of more than 10 db, with near-perfect reconstruction of both obstructions and obstructed content; though emphasize that these results represent a validation of the models in a simplified imaging setting, and are not fully representative of performance across diverse in-the-wild scenarios.

### Shadow Removal

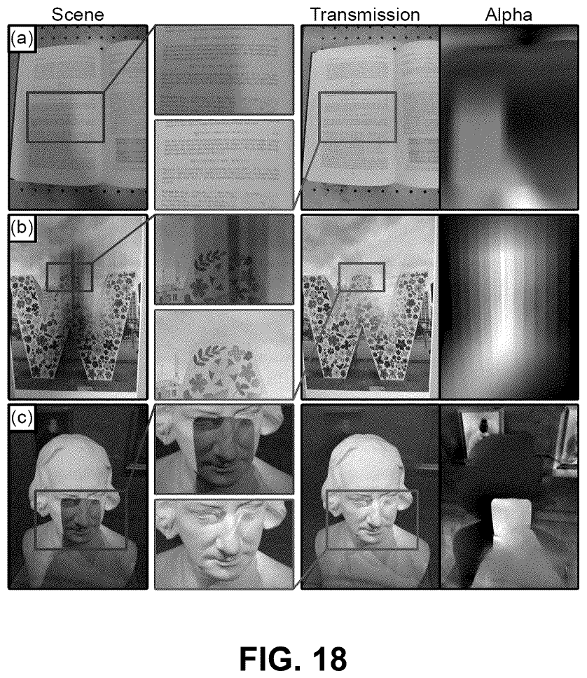

FIG. 18 shows exemplary shadow removal results under different lighting conditions: partially diffuse in row (a), multiple point in row (b), and single point in row (c). Referring to FIG. 18, shadow removal results were demonstrated for scenes with disparate lighting conditions: row (a) shows a book illuminated by a diffuse overhead lamp, row (b) shows a poster illuminated by an array of LEDs, and row (c) shows a bust illuminated by a strong point light source.

It is noted that the grid of LEDs act as a set of point light sources, producing multiple copies of the shadow to be overlayed on the scene. In all settings we are able to extract the shadow with the same obstruction network defined in the shadow removal application in Table 2, further reinforcing the image fitting findings from FIG. 15. Namely that coordinate networks with low-resolution multi-resolution hash encodings are able to effectively fit both scenes comprised of smooth gradients, as in the diffuse shadow case, and limited numbers of image discontinuities, as in the multiple point source case. In row (c) it is seen that while the photographer-cast shadow is successfully removed from the bust, the shadows cast by other light sources are left intact. This reinforces that our proposed model is separating shadows based not only on their color, but on the motion they exhibit in the scene; as the other shadows cast on the bust undergo the same parallax motion as the bust itself.

### Challenging Settings

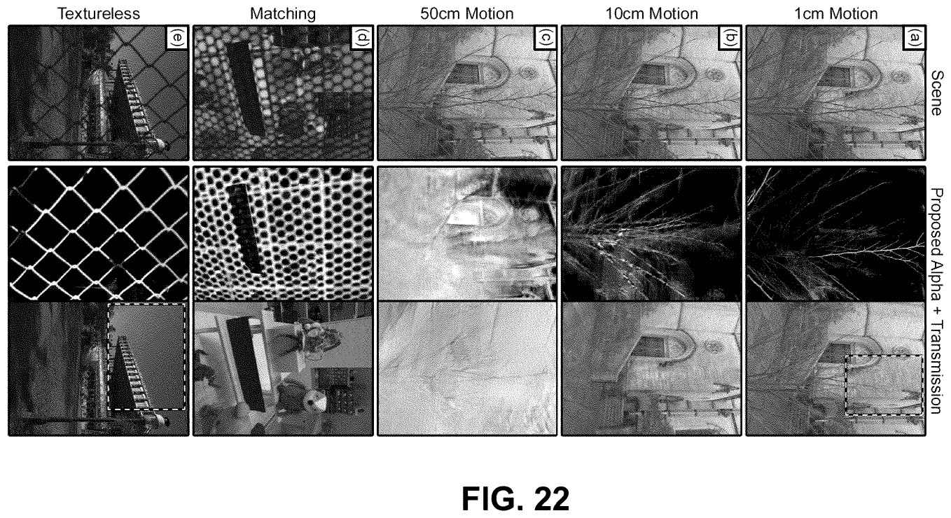

FIG. 22 shows exemplary challenging image reconstruction cases including varying scales of camera motion, overlap between occluder and transmission colors, and residual signal left on scene content in low-texture regions. Areas of interest highlighted with dashed border. Referring to FIG. 22, a set of challenging imaging settings was compiled in which highlight areas where the proposed approach could be improved. One limitation of this work is that it cannot generate unseen content. While this means it cannot hallucinate features from unreliable image priors, it also means that it is highly parallax-dependent for generating accurate reconstructions. This is highlighted in FIG. 22 rows (a-c), where with hand motion on the scale of 1 cm is only enough to separate and remove the topmost branch of the occluding plant. Motion on the scale of 10 cm is enough to remove most of the branches, but larger motion on the scale of half a meter in diameter causes the reconstruction to break down. This is likely due to the small motion and angle assumptions in our camera model, as it is not able to successfully jointly align the input image data and learn its multi-layer representation. Thus work on large motion or wide-angle data for large obstruction removal—e.g., removing telephone poles blocking the view of a building—remains an open problem. FIG. 22 row (d) demonstrates the challenge of estimating an accurate alpha matte when the transmitted and obstructed content are matching colors. In this case, although the obstruction is “removed”, we see that the alpha matte is missing a gap around the black object in the scene behind the occluder. In this region the model does not need to use the obstruction layer to represent pixels that are already black in the transmission layer—in fact, the alpha regularization term Ra would penalize this. Thus the alpha matte is actually a produce of both the actual alpha of the obstruction and its relative color difference with what it is occluding. FIG. 22 row (e) highlights a related problem. In regions where the transmission layer is low-texture, and lacks parallax cues, it is ambiguous what is being obstructed and where the border of the obstruction lies. Thus ghosting artifacts are left behind in areas such as the sky of the Textureless scene. What is noteworthy, however, is that these are also exactly the regions in which in-painting methods such as Lama [58] are most successful, as there are no complex textures that need to be recovered from incomplete data, leaving a hybrid model as an interesting direction for future work.

### Additional Experiments and Analysis

Gradient Loss A significant challenge posed by the task of aggregating long-burst data is the so-called problem of “regression to the mean”. When minimizing a metric such as relative mean-square error, which penalizes small color differences significantly less than large discrepancies, the final reconstruction is encouraged to be smoother than the original input data [2]. Thus, in developing our approach we explored—but ultimately did not use—a form of gradient penalty loss:

$${ℒ}_{G} = \vert ( Δ c - Δ \hat{c} ) / ( s g ( Δ c ) + ∈ ) {\vert}^{2} \qquad ( 15 )$$

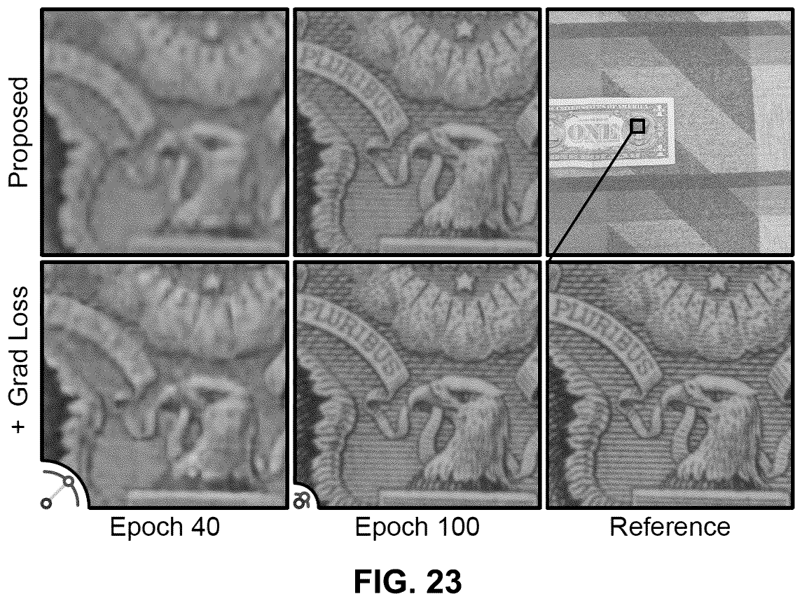

FIG. 23 shows Visualization of the effects of gradient loss [symbol] _{G} on image reconstruction at 25× zoom. Inset bottom left is the radius of perturbation at epoch 40 and epoch 100, the end of training.

Rather than sample a grid of points around u\hat{ }O, v\hat{ }O and u\hat{ }t, v\hat{ }T or perform a second pass over the image networks [51] to compute Jacobians, we compute color gradients Δc by pairing each ray with an input perturbed in a random direction

$$Δc = I ( u , v , t ) - I ( \tilde{u} , \tilde{v} , t ) \tilde{u} , \tilde{v} = u + r cos ( ϕ ) , v + r sin ( ϕ ) , ϕ ∼ u ( 0 , 2 π ) , \qquad ( 16 )$$

where r determines the magnitude of the perturbation. The estimated color gradient Δc is similarly calculated for the output colors of our model. Illustrated in FIG. 23, by reducing radius r from multi-pixel to sub-pixel perturbations during training, we are able to improve fine feature recovery in the final reconstruction via gradient loss [symbol] _{G} without significantly impacting training time—as perturbed samples are also re-used for regular photometric loss calculation [symbol] ₚ. However, as we do not apply any demosaicing or post-processing to our input Bayer array data, we find this loss can also lead to increased color-fringing artifacts—the red tint in the bottom row of FIG. 23. For these reasons, and poor convergence in noisy scenes, we did not include this loss in the final model. However, there may be potentially interesting avenue of future research into a jointly trained demosaicing module to robustly estimate real color gradient directly from quantized and discretized Bayer array values.

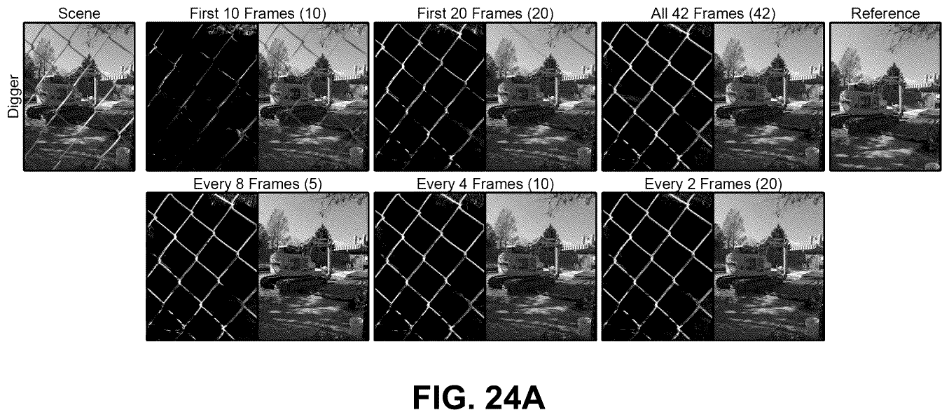

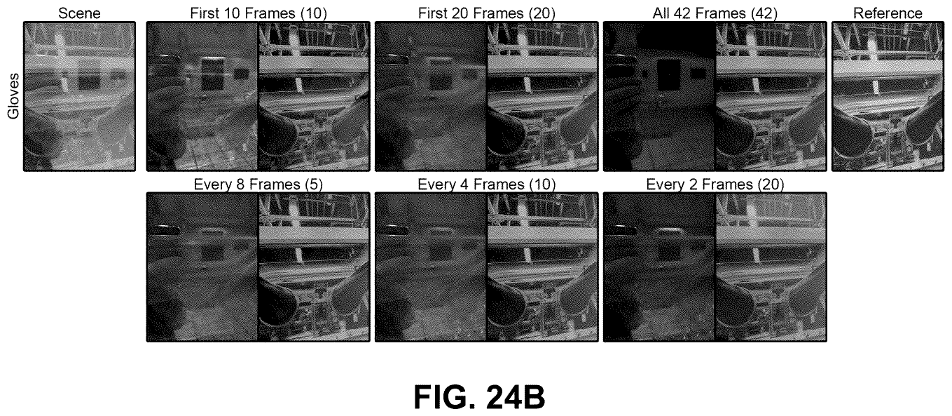

FIGS. 24A-B shows an exemplary ablation study on the effects of the number of input frames or duration of capture on transmission layer reconstruction and estimated alpha matte. Total number of frames input into the model denoted by the number in parentheses—e.g., (10)=ten frames.

### Alpha Regularization Ablation

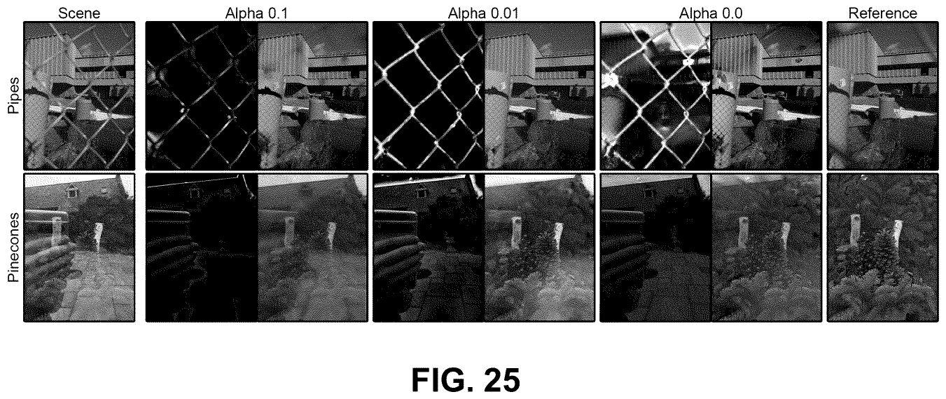

FIG. 25 shows results from an exemplary ablation study on the effects of alpha regularization weight fa on transmission layer reconstruction and estimated alpha matte. Referring to FIG. 25, the effects of alpha regularization weight η_{α} on reconstruction were visualized. The primary function of this regularization is to remove low-parallax content from the obstruction layer, as there is no alpha penalty for reconstructing the same content via the transmission layer. As seen in the Pipes example, without alpha regularization the obstruction layer is able to freely reconstruct part of the transmitted scene content such as the sky, the pipes, and the walls of the occluded buildings. A small penalty of η_{α}=0.01 is enough to remove this unwanted content from the obstruction layer, while η_{α}=0.1 is enough to also start removing parts of the actual obstruction. Contrastingly, in the case of reflection scenes such as Pinecones, even a relatively small alpha regularization weight of η_{α}=0.01 removes part of the actual reflection—leaving behind a grey smudge in the bottom right corner of the reconstruction. As reflections are typically partially transparent obstructions, and can occupy a large area of the scene, removing them purely photometrically is ill-conditioned. There is no visual difference between a gray reflector covering the entire view of the camera and the scene actually being gray. Thus η_{α} can also be a user-dependent parameter tuned to the desired “amount” of reflection removal.

### Frame Count Ablation

Thus far all 42 frames have been used in each long-burst capture as input to the present method, but it is highlighted that this is not a requirement of the approach. The training process can be applied to any number of frames—within computational limits. In FIGS. 24A-B reconstruction results are showcased for both subsampled captures, where only every k-th frame of the image sequence is kept for training, and shortened captures, where only the first n frames are retained. Similar to the problem of depth reconstruction [9], it was found that obstruction removal performance directly depends on the total amount of parallax in the input. Sampling the first 10 frames—approximately 0.5 seconds of recording—results in diminished obstruction removal for both the Digger and Gloves scenes as the obstruction exhibits significantly less motion during the capture. In contrast, given a five frame input sampled evenly across the full two-second capture, our proposed approach is able to successfully reconstruct and remove the obstruction. This subsampled scene also trains considerably faster, converging in only 3 minutes as less frames need to be sampled per batch—or equivalently more rays can be sampled from each frame for each iteration. This further validates the benefit of a long burst capture.

### Flow Encoding Size Ablation

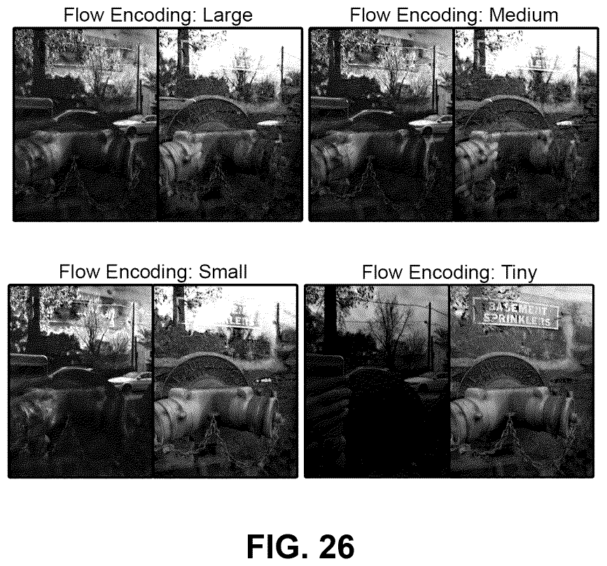

A key model parameter which controls layer separation, as discussed in Section A, is the size of the encoding for our neural spline flow fields. FIG. 26 shows results from an exemplary ablation study on the effects of flow encoding size (e.g., Table 1) on transmission layer reconstruction and estimated alpha matte. In FIG. 26 the effects on obstruction removal of over-parameterizing this flow representation are illustrated. When the two layers are undergoing simple motion caused by parallax from natural hand tremor, a Tiny flow encoding is able to represent and pull apart the motion of the reflected and transmitted content. However, high-resolution neural spline fields, just like a traditional flow volume h(u, v, t), can quickly overfit the scene and mix content between layers. This can been seen clearly in the Large flow encoding example where the reflected phone, trees, and parked car appear in both the obstruction alpha matte and transmission image. Thus, it is critical to the success of the method to construct a task-specific neural spline field representation appropriate for the expected amount and density of scene motion.

### Applications to Scene Editing

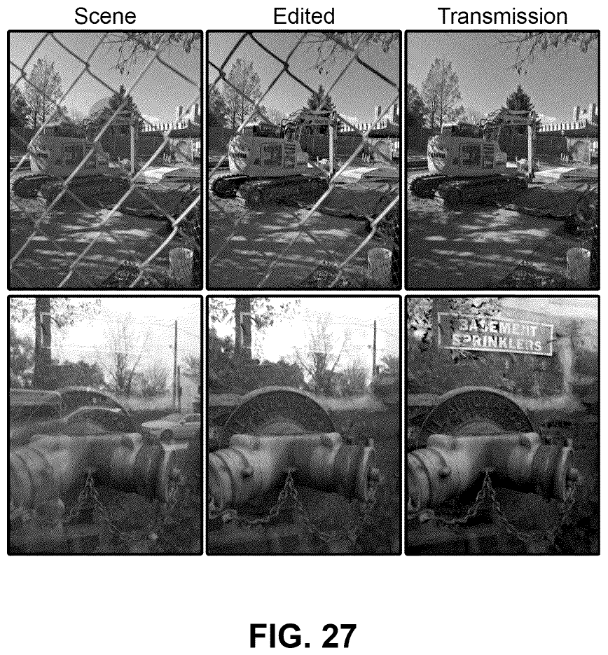

FIG. 27 shows a demonstration of user-interactive scene editing facilitated by layer separation. Only the user-selected region of the obstruction, highlighted in red, is removed without affecting surrounding scene content, see text. Referring to FIG. 27, the scene editing functionality facilitated by the presented methods layer separation is showcased. As an image model is estimated for both the transmission and obstruction, one is not limited to only removing a layer but can independently manipulate them. In this example both layers were rasterized to RGBA images and input them into an image editor. The user is then able to highlight and delete a portion of the occlusion while retaining its other content. Thus, physically unrealizable photographs can be created such as only the fence appearing to be behind the Digger, or selectively remove the photographer's hand and parked car from the Hydrant scene.

FIG. 28 depicts a computing device that may be used in various aspects, such as the devices depicted in FIG. 1. With regard to the example architecture of FIG. 1, the camera device 102, computing device 104, storage service 106, application service 108, and user device 110, may each be implemented in one or more instances of a computing device 2800 of FIG. 28. The computer architecture shown in FIG. 28 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 2.

The computing device 2800 may include a baseboard, or “motherboard,” which is a printed circuit board to which a multitude of components or devices may be connected by way of a system bus or other electrical communication paths. One or more central processing units (CPUs) 2804 may operate in conjunction with a chipset 2806. The CPU(s) 2804 may be standard programmable processors that perform arithmetic and logical operations necessary for the operation of the computing device 2800.

The CPU(s) 2804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 2804 may be augmented with or replaced by other processing units, such as GPU(s) 2805. The GPU(s) 2805 may comprise processing units specialized for but not necessarily limited to highly parallel computations, such as graphics and other visualization-related processing.

A chipset 2806 may provide an interface between the CPU(s) 2804 and the remainder of the components and devices on the baseboard. The chipset 2806 may provide an interface to a random access memory (RAM) 2808 used as the main memory in the computing device 2800. The chipset 2806 may further provide an interface to a computer-readable storage medium, such as a read-only memory (ROM) 2820 or non-volatile RAM (NVRAM) (not shown), for storing basic routines that may help to start up the computing device 2800 and to transfer information between the various components and devices. ROM 2820 or NVRAM may also store other software components necessary for the operation of the computing device 2800 in accordance with the aspects described herein.

The computing device 2800 may operate in a networked environment using logical connections to remote computing nodes and computer systems through local area network (LAN) 2816. The chipset 2806 may include functionality for providing network connectivity through a network interface controller (NIC) 2822, such as a gigabit Ethernet adapter. A NIC 2822 may be capable of connecting the computing device 2800 to other computing nodes over a network 2816. It should be appreciated that multiple NICs 2822 may be present in the computing device 2800, connecting the computing device to other types of networks and remote computer systems.

The computing device 2800 may be connected to a mass storage device 2828 that provides non-volatile storage for the computer. The mass storage device 2828 may store system programs, application programs, other program modules, and data, which have been described in greater detail herein. The mass storage device 2828 may be connected to the computing device 2800 through a storage controller 2824 connected to the chipset 2806. The mass storage device 2828 may consist of one or more physical storage units. A storage controller 2824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 2800 may store data on a mass storage device 2828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 2828 is characterized as primary or secondary storage and the like.

For example, the computing device 2800 may store information to the mass storage device 2828 by issuing instructions through a storage controller 2824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 2800 may further read information from the mass storage device 2828 by detecting the physical states or characteristics of one or more particular locations within the physical storage units.

In addition to the mass storage device 2828 described above, the computing device 2800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 2800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“ID-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 2828 depicted in FIG. 28, may store an operating system utilized to control the operation of the computing device 2800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 2828 may store other system or application programs and data utilized by the computing device 2800.

The mass storage device 2828 or other computer-readable storage media may also be encoded with computer-executable instructions, which, when loaded into the computing device 2800, transforms the computing device from a general-purpose computing system into a special-purpose computer capable of implementing the aspects described herein. These computer-executable instructions transform the computing device 2800 by specifying how the CPU(s) 2804 transition between states, as described above. The computing device 2800 may have access to computer-readable storage media storing computer-executable instructions, which, when executed by the computing device 2800, may perform the methods described in relation to FIG. 2.

A computing device, such as the computing device 2800 depicted in FIG. 28, may also include an input/output controller 2832 for receiving and processing input from a number of input devices, such as a keyboard, a mouse, a touchpad, a touch screen, an electronic stylus, or other type of input device. Similarly, an input/output controller 2832 may provide output to a display, such as a computer monitor, a flat-panel display, a digital projector, a printer, a plotter, or other type of output device. It will be appreciated that the computing device 2800 may not include all of the components shown in FIG. 28, may include other components that are not explicitly shown in FIG. 28, or may utilize an architecture completely different than that shown in FIG. 28.

As described herein, a computing device may be a physical computing device, such as the computing device 2800 of FIG. 28. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

As used in the specification and the appended claims, the singular forms “a,” “an,” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise. All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes. As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

### Aspects

The following Aspects are illustrative only and do not limit the scope of the present disclosure or the appended claims. Any part or parts of any one or more Aspects can be combined with any part or parts of any one or more other Aspects.

Aspect 1. A method comprising: determining a plurality of images associated with a camera device; generating a camera model indicative of the camera device in a three dimensional space; generating, based on the plurality of images, at least one neural network trained to map input image coordinates to vectors of spline control points; generating, based on the camera model and the at least one neural network, at least one reconstructed image; and causing storage of the at least one reconstructed image.

Aspect 2. The method of Aspect 1, wherein the reconstructed image modifies, removes, adds, or a combination thereof one or more of an object or a plane from one of the plurality of images.

Aspect 3. The method of any one of Aspects 1-2, wherein generating the at least one reconstructed image comprises using the at least one neural network to interpolate a color value for a pixel based on more than one spline control point associated with the pixel.

Aspect 4. The method of any one of Aspects 1-3, wherein the plurality of images are offset from each other in space due to motion of the camera device while capturing the plurality of images, wherein the at least one neural network is trained such that pixels blocked by an obstruction in one image may be reconstructed using based on pixels in another image of the plurality of images.

Aspect 5. The method of any one of Aspects 1-4, wherein the spline control points comprise locations on a polynomial function.

Aspect 6. The method of any one of Aspects 1-5, wherein the at least one neural network maps a coordinate of an image to color values at each of the spline control points.

Aspect 7. The method of any one of Aspects 1-6, wherein each spline control point represents a different point of time relative to the plurality of images.

Aspect 8. The method of any one of Aspects 1-7, further comprising receiving movement data indicative of movement while at least a portion of the plurality of images are captured.

Aspect 9. The method of Aspect 8, wherein the movement data comprises sensor metadata, gyroscope measurements, accelerometer data, or camera metadata.

Aspect 10. The method of any one of Aspects 8-9, further comprising initializing the camera model based on the movement data by specifying one or more of a location of the camera device, a rotation of the camera device, an angle of the camera device, or a translation of the camera device.

Aspect 11. The method of any one of Aspects 1-10, wherein the plurality of images comprises a sequence of images, a burst of images captured over at least 2 seconds, a burst of images captured over at least 1 second, a burst of images captured in a range of about 0.5 seconds to 2 seconds, a sequence in a range of about 10 to about 40 frames, or a combination thereof.

Aspect 12. The method of any one of Aspects 1-11, wherein determining the plurality of images associated with the camera device comprises one or more of receiving the plurality of images from the camera device, capturing the plurality of images, or accessing the plurality of images in storage.

Aspect 13. The method of any one of Aspects 1-12, wherein generating the at least one neural network comprises training the at least one neural network based on stochastic gradient descent.

Aspect 14. The method of any one of Aspects 1-13, generating the at least one neural network comprises optimizing a photometric reconstruction loss.

Aspect 15. The method of any one of Aspects 1-14, wherein the at least one neural network is trained to separate a foreground feature from background in the plurality of images.

Aspect 16. The method of any one of Aspects 1-15, wherein generating the at least one neural network trained to map input image coordinates to vectors of the spline control points comprises: generating data representing a first neural field flow for a first two dimensional plane object at a first location in three dimensional space in the cameral model; and training the first neural field flow based on using the first neural field flow to generate an approximate image and minimizing a difference between the approximate image an an image of the plurality of images.

Aspect 17. The method of Aspect 16, wherein generating the at least one neural network trained to map input image coordinates to vectors of the spline control points comprises: generating data representing a second neural field flow for a second two dimensional plane object at a second location in three dimensional space in the cameral model; and training the second neural field flow based on using the second neural field flow to generate the approximate image and minimizing the difference between approximate image and the image of the plurality of images.

Aspect 18. The method of Aspect 17, wherein the at least one neural network comprises a first neural field flow network representing motion of at least one object in a first plane in the three-dimensional space and a second neural field flow network representing motion of at least one object in a second plane in the three dimensional space.

Aspect 19. The method of any one of Aspects 17-18, wherein generating the at least one neural network comprises generating an alpha map indicating locations of pixels of one or more of an obstruction or a reflection in the plurality of images.

Aspect 20. The method of any one of Aspects 1-19, wherein the at least one neural network comprises at least one neural spline field model of flow.

Aspect 21. The method of Aspect 20, wherein the neural spline field model comprises a continuous flow representation based on fitting a polynomial function to the spline control points.

Aspect 22. The method of any one of Aspects 1-21, wherein the at least one neural network comprises at least one neural field based alpha map.

Aspect 23. The model of Aspect 22, wherein the alpha map comprises an actual alpha map and an inverse alpha map.

Aspect 24. The method of any one of Aspects 1-23, wherein the at least one neural network separates one or more foreground features from a background, wherein the one or more foreground features comprise one or more of occlusions, reflections, shadows, or noise.

Aspect 25. The method of Aspect 24, wherein the at least one neural network comprises one or more layers comprising an obstruction layer, a transmission layer and/or a combination thereof.

Aspect 26. The method of any one of Aspects 1-25, wherein the at least one reconstructed image comprises a neural field image.

Aspect 27. The method of any one of Aspects 1-26, wherein the at least one reconstructed image comprises a first image representing a first plane of the three dimensional space and a second image representing a second plane of the three dimensional space.

Aspect 28. The method of Aspect 27, wherein the first plane represents an obstruction layer and the second plane represents a transmission layer.

Aspects 29. The method of any one of Aspects 27-28, wherein the first plane is located in between the second plane and the camera device in the three dimensional space of the camera model.

Aspect 30. The method of any one of Aspects 1-29, wherein the camera device comprises one or more of a user device, mobile device, handheld camera, mobile camera, mobile telephone, microscope, telescope, and light field camera, time-of-flight camera, hyperspectral camera, server device, or x-ray computed tomography device.

Aspect 31. A device comprising: one or more processors; and a memory storing instructions that, when executed by the one or more processors, cause the device to perform the methods of any one of Aspects 1-30.

Aspect 32. A non-transitory computer-readable medium storing instructions that, when executed by one or more processors, cause a device to perform the methods of any one of Aspects 1-30.

Aspect 33. A system comprising: a camera device; and a computing device comprising one or more processors, and a memory, wherein the memory stores instructions that, when executed by the one or more processors, cause the camera device to perform the methods of any one of Aspects 1-30.

### REFERENCES

[1] Hannan Adeel, Muhammad Mohsin Riaz, and Syed Sohaib Ali. De-fencing and multi-focus fusion using markov random field and image inpainting. IEEE Access, 10:35992-36005, 2022. 2
[2] Yuval Bahat and Tomer Michaeli. Explorable super resolution. In Proceedings of the IEEE/CVF Conference on Computer Vision and Pattern Recognition, pages 2716-2725, 2020. 19
[3] Jonathan T Barron, Ben Mildenhall, Matthew Tancik, Peter Hedman, Ricardo Martin-Brualla, and Pratul P Srinivasan. Mip-nerf: A multiscale representation for anti-aliasing neural radiance fields. In Proceedings of the IEEE/CVF International Conference on Computer Vision, pages 5855-5864, 2021.2
[4] Jonathan T Barron, Ben Mildenhall, Dor Verbin, Pratul P Srinivasan, and Peter Hedman. Zip-nerf: Anti-aliased grid-based neural radiance fields. arXiv preprint arXiv:2304.06706, 2023. 2
[5] Mario Bertero, Patrizia Boccacci, and Christine De Mol. Introduction to inverse problems in imaging. CRC press, 2021. 2
[6] Goutam Bhat, Martin Danelljan, Luc Van Gool, and Radu Timofte. Deep burst super-resolution. In Proceedings of the IEEE/CVF Conference on Computer Vision and Pattern Recognition, pages 9209-9218, 2021. 1
[7] Vladan Blahnik and Oliver Schindelbeck. Smartphone imaging technology and its applications. Advanced Optical Technologies, 10(3):145-232, 2021. 1
[8] Qifeng Chen and Vladlen Koltun. A simple model for intrinsic image decomposition with depth cues. In Proceedings of the IEEE international conference on computer vision, pages 241-248, 2013. 2
[9] Ilya Chugunov, Yuxuan Zhang, and Felix Heide. Shakes on a plane: Unsupervised depth estimation from unstabilized photography. In Proceedings of the IEEE/CVF Conference on Computer Vision and Pattern Recognition, pages 13240-13251, 2023. 1, 2, 3, 4, 5, 21
[10] Ilya Chugunov, Yuxuan Zhang, Zhihao Xia, Xuaner Zhang, Jiawen Chen, and Felix Heide. The implicit values of a good hand shake: Handheld multi-frame neural depth refinement. In Proceedings of the IEEE/CVF Conference on Computer Vision and Pattern Recognition, pages 2852-2862, 2022. 1, 2, 4, 6, 11, 12
[11] Mauricio Delbracio, Damien Kelly, Michael S Brown, and Peyman Milanfar. Mobile computational photography: A tour. arXiv preprint arXiv:2102.09000, 2021. 1, 2, 3
[12] Muhammad Shahid Farid, Arif Mahmood, and Marco Grangetto. Image de-fencing framework with hybrid in-painting algorithm. Signal, Image and Video Processing, 10:1193-1201, 2016. 2
[13] Gerald E Farin. Curves and surfaces for CAGD: a practical guide. Morgan Kaufmann, 2002. 3
[14] Orazio Gallo, Alejandro Troccoli, Jun Hu, Kari Pulli, and Jan Kautz. Locally non-rigid registration for mobile hdr photography. In Proceedings of the IEEE conference on computer vision and pattern recognition Workshops, pages 49-56, 2015. 2
[15] Yosef Gandelsman, Assaf Shocher, and Michal Irani. “double-dip”: unsupervised image decomposition via coupled deep-image-priors. In Proceedings of the IEEE/CVF Conference on Computer Vision and Pattern Recognition, pages 11026-11035, 2019. 2
[16] Clément Godard, Kevin Matzen, and Matt Uyttendaele. Deep burst denoising. In Proceedings of the European conference on computer vision (ECCV), pages 538-554, 2018. 2
[17] Google. See in the dark with night sight. https://blog.google/products/pixel/see-light-night-sight/, 2018. Accessed: 2023-10-24. 1, 2
[18] Google. Astrophotography with night sight on pixel phones. https://blogresearch.google/2019/11/astrophotography-with-night-sight-on.html, 2019. Accessed: 2023 Oct. 24. 1, 2
[19] Yuan-Chen Guo, Di Kang, Linchao Bao, Yu He, and Song-Hai Zhang. Nerfren: Neural radiance fields with reflections. In Proceedings of the IEEE/CVF Conference on Computer Vision and Pattern Recognition (CVPR), pages 18409-18418, June 2022. 8, 14, 18
[20] Divyanshu Gupta, Shorya Jain, Utkarsh Tripathi, Pratik Chattopadhyay, and Lipo Wang. Fully automated image de-fencing using conditional generative adversarial networks, 2019. 1
[21] Hyowon Ha, Sunghoon Im, Jaesik Park, Hae-Gon Jeon, and In So Kweon. High-quality depth from uncalibrated small motion clip. In Proceedings of the IEEE conference on computer vision and pattern Recognition, pages 5413-5421, 2016. 1,4
[22] Richard Hartley and Andrew Zisserman. Multiple view geometry in computer vision. Cambridge university press, 2003. 3, 4
[23] Samuel W Hasinoff, Dillon Sharlet, Ryan Geiss, Andrew Adams, Jonathan T Barron, Florian Kainz, Jiawen Chen, and Marc Levoy. Burst photography for high dynamic range and low-light imaging on mobile cameras. ACM Transactions on Graphics (ToG), 35(6):1-12, 2016. 1, 2
[24] Kurt Hornik, Maxwell Stinchcombe, and Halbert White. Multilayer feedforward networks are universal approximators. Neural networks, 2(5):359-366, 1989. 4
[25] Qiming Hu and Xiaojie Guo. Single image reflection separation via component synergy. In Proceedings of the IEEE/CVF International Conference on Computer Vision (ICCV), pages 13138-13147, October 2023. 2, 8, 14, 18
[26] Sunghoon Im, Hyowon Ha, Gyeongmin Choe, Hae-Gon Jeon, Kyungdon Joo, and In So Kweon. High quality structure from small motion for rolling shutter cameras. In Proceedings of the IEEE International Conference on Computer Vision, pages 837-845, 2015. 2, 3, 4
[27] Nima Khademi Kalantari, Ravi Ramamoorthi, et al. Deep high dynamic range imaging of dynamic scenes. ACM Trans. Graph., 36(4):144-1, 2017. 1
[28] Yoni Kasten, Dolev Ofri, Oliver Wang, and Tali Dekel. Layered neural atlases for consistent video editing, 2021. 3, 4, 8
[29] Diederik P Kingma and Jimmy Ba. Adam: A method for stochastic optimization. arXiv preprint arXiv:1412.6980, 2014.7
[30] Alexander Kirillov, Eric Mintun, Nikhila Ravi, Hanzi Mao, Chloe Rolland, Laura Gustafson, Tete Xiao, Spencer Whitehead, Alexander C Berg, Wan-Yen Lo, et al. Segment anything. In Proceedings of the IEEE/CVF International Conference on Computer Vision, pages 4015-4026, 2023. 8
[31] Fredrik Kjolstad, Shoaib Kamil, Stephen Chou, David Lu-gato, and Saman Amarasinghe. The tensor algebra compiler. Proceedings of the ACM on Programming Languages, 1(OOPSLA):1-29, 2017. 2
[32] Keitaro Kume and Masaaki Ikehara. Single image fence removal using fast fourier transform. In 2023 IEEE International Conference on Consumer Electronics (ICCE), pages 1-5, 2023. 2
[33] Bruno Lecouat, Thomas Eboli, Jean Ponce, and Julien Mairal. High dynamic range and super-resolution from raw image bursts. arXiv preprint arXiv:2207.14671, 2022. 1, 2
[34] Chenyang Lei and Qifeng Chen. Robust reflection removal with reflection-free flash-only cues. In IEEE/CVF Conference on Computer Vision and Pattern Recognition (CVPR), 2021.2
[35] Chenyang Lei, Xuhua Huang, Mengdi Zhang, Qiong Yan, Wenxiu Sun, and Qifeng Chen. Polarized reflection removal with perfect alignment in the wild. In Proceedings of the IEEE/CVF conference on computer vision and pattern recognition, pages 1750-1758, 2020. 2
[36] Chenyang Lei, Xudong Jiang, and Qifeng Chen. Robust reflection removal with flash-only cues in the wild, 2022. 2
[37] Yu Li and Michael S. Brown. Exploiting reflection change for automatic reflection removal. In Proceedings of the IEEE International Conference on Computer Vision (ICCV), December 2013. 2
[38] Zhaoshuo Li, Thomas Müller, Alex Evans, Russell H Taylor, Mathias Unberath, Ming-Yu Liu, and Chen-Hsuan Lin. Neuralangelo: High-fidelity neural surface reconstruction. In Proceedings of the IEEE/CVF Conference on Computer Vision and Pattern Recognition, pages 8456-8465, 2023. 5
[39] Zhengqi Li, Qiangian Wang, Forrester Cole, Richard Tucker, and Noah Snavely. Dynibar: Neural dynamic image-based rendering. In Proceedings of the IEEE/CVF Conference on Computer Vision and Pattern Recognition, pages 4273-4284, 2023. 3
[40] Orly Liba, Kiran Murthy, Yun-Ta Tsai, Tim Brooks, Tianfan Xue, Nikhil Karnad, Qiurui He, Jonathan T Barron, Dillon Sharlet, Ryan Geiss, et al. Handheld mobile photography in very low light. ACM Trans. Graph., 38(6):164-1, 2019. 1, 2
[41] Lahav Lipson, Zachary Teed, and Jia Deng. Raft-stereo: Multilevel recurrent field transforms for stereo matching. arXiv preprint arXiv:2109.07547, 2021. 3
[42] Yunfei Liu, Yu Li, Shaodi You, and Feng Lu. Semantic guided single image reflection removal, 2022. 2
[43] Yu-Lun Liu, Wei-Sheng Lai, Ming-Hsuan Yang, Yung-Yu Chuang, and Jia-Bin Huang. Learning to see through obstructions. In IEEE Conference on Computer Vision and Pattern Recognition, 2020. 2, 8, 13, 14, 18
[44] Erika Lu, Forrester Cole, Tali Dekel, Andrew Zisserman, William T Freeman, and Michael Rubinstein. Omnimatte: Associating objects and their effects in video. In CVPR, 2021. 2,8
[45] Tom Mertens, Jan Kautz, and Frank Van Reeth. Exposure fusion: A simple and practical alternative to high dynamic range photography. In Computer graphics forum, volume 28, pages 161-171. Wiley Online Library, 2009. 2
[46] Ben Mildenhall, Jonathan T Barron, Jiawen Chen, Dillon Sharlet, Ren Ng, and Robert Carroll. Burst denoising with kernel prediction networks. In Proceedings of the IEEE conference on computer vision and pattern recognition, pages 2502-2510, 2018. 1, 2
[47] Ben Mildenhall, Peter Hedman, Ricardo Martin-Brualla, Pratul P Srinivasan, and Jonathan T Barron. Nerf in the dark: High dynamic range view synthesis from noisy raw images. In Proceedings of the IEEE/CVF Conference on Computer Vision and Pattern Recognition, pages 16190-16199, 2022. 5
[48] Ben Mildenhall, Pratul P Srinivasan, Matthew Tancik, Jonathan T Barron, Ravi Ramamoorthi, and Ren Ng. Nerf: Representing scenes as neural radiance fields for view synthesis. In European conference on computer vision, pages 405-421. Springer, 2020. 4, 12
[49] Thomas Müller, Alex Evans, Christoph Schied, and Alexander Keller. Instant neural graphics primitives with a multiresolution hash encoding. arXiv preprint arXiv:2201.05989, 2022. 2, 4
[50] Thomas Müller, Fabrice Rousselle, Jan Nov'ak, and Alexander Keller. Real-time neural radiance caching for path tracing. arXiv preprint arXiv:2106.12372, 2021. 7
[51] Seonghyeon Nam, Marcus A. Brubaker, and Michael S. Brown. Neural image representations for multi-image fusion and layer separation, 2022. 1, 2, 3, 4, 8, 13, 14, 18, 19
[52] Simon Niklaus, Xuaner Cecilia Zhang, Jonathan T. Barron, Neal Wadhwa, Rahul Garg, Feng Liu, and Tianfan Xue. Learned dual-view reflection removal, 2020. 2
[53] Minwoo Park, Kyle Brocklehurst, Robert T Collins, and Yanxi Liu. Image de-fencing revisited. In Computer Vision—ACCV 2010: 10th Asian Conference on Computer Vision, Queenstown, New Zealand, Nov. 8-12, 2010, Revised Selected Papers, Part IV 10, pages 422-434. Springer, 2011. 2
[54] Zeqi Shen, Shuo Zhang, and Youfang Lin. Light field reflection and background separation network based on adaptive focus selection. IEEE Transactions on Computational Imaging, 9:435-447, 2023. 2
[55] YiChang Shih, Dilip Krishnan, Fredo Durand, and William T. Freeman. Reflection removal using ghosting cues. In Proceedings of the IEEE Conference on Computer Vision and Pattern Recognition (CVPR), June 2015. 1, 2
[56] Vincent Sitzmann, Julien Martel, Alexander Bergman, David Lindell, and Gordon Wetzstein. Implicit neural representations with periodic activation functions. Advances in Neural Information Processing Systems, 33, 2020. 2
[57] Yu Sun, Jiaming Liu, Mingyang Xie, Brendt Wohlberg, and Ulugbek S Kamilov. Coil: Coordinate-based internal learning for tomographic imaging. IEEE Transactions on Computational Imaging, 7:1400-1412, 2021. 2
[58] Roman Suvorov, Elizaveta Logacheva, Anton Mashikhin, Anastasia Remizova, Arsenii Ashukha, Aleksei Silvestrov, Naejin Kong, Harshith Goka, Kiwoong Park, and Victor Lempitsky. Resolution-robust large mask inpainting with fourier convolutions. arXiv preprint arXiv:2109.07161, 2021. 8, 13, 14, 18, 19
[59] Hanlin Tan, Xiangrong Zeng, Shiming Lai, Yu Liu, and Mao-jun Zhang. Joint demosaicing and denoising of noisy bayer images with admm. In 2017 IEEE International Conference on Image Processing (ICIP), pages 2951-2955. IEEE, 2017. 2
[60] Matthew Tancik, Pratul Srinivasan, Ben Mildenhall, Sara Fridovich-Keil, Nithin Raghavan, Utkarsh Singhal, Ravi Ra-mamoorthi, Jonathan Barron, and Ren Ng. Fourier features let networks learn high frequency functions in low dimensional domains. Advances in Neural Information Processing Systems, 33:7537-7547, 2020. 2
[61] Zachary Teed and Jia Deng. Raft: Recurrent all-pairs field transforms for optical flow. In Computer Vision—ECCV 2020: 16th European Conference, Glasgow, UK, Aug. 23-28, 2020, Proceedings, Part 1116, pages 402-419. Springer, 2020. 8
[62] Zachary Teed and Jia Deng. Raft-3d: Scene flow using rigid-motion embeddings. In Proceedings of the IEEE/CVF conference on computer vision and pattern recognition, pages 8375-8384, 2021. 3
[63] Christoph Vogel, Konrad Schindler, and Stefan Roth. Piece-wise rigid scene flow. In Proceedings of the IEEE International Conference on Computer Vision, pages 1377-1384, 2013. 3
[64] Kaixuan Wei, Jiaolong Yang, Ying Fu, David Wipf, and Hua Huang. Single image reflection removal exploiting misaligned training data and network enhancements. In Proceedings of the IEEE/CVF Conference on Computer Vision and Pattern Recognition, pages 8178-8187, 2019. 12
[65] Bartlomiej Wronski, Ignacio Garcia-Dorado, Manfred Ernst, Damien Kelly, Michael Krainin, Chia-Kai Liang, Marc Levoy, and Peyman Milanfar. Handheld multi-frame super-resolution. ACM Transactions on Graphics (TOG), 38(4):1-18, 2019. 1, 2, 4
[66] Wei Xiong, Jiahui Yu, Zhe Lin, Jimei Yang, Xin Lu, Connelly Barnes, and Jiebo Luo. Foreground-aware image in-painting. In Proceedings of the IEEE/CVF conference on computer vision and pattern recognition, pages 5840-5848, 2019.2
[67] Tianfan Xue, Michael Rubinstein, Ce Liu, and William T Freeman. A computational approach for obstruction-free photography. ACM Transactions on Graphics (TOG), 34(4):1-11, 2015. 2
[68] Guandao Yang, Sagie Benaim, Varun Jampani, Kyle Genova, Jonathan Barron, Thomas Funkhouser, Bharath Hariharan, and Serge Belongie. Polynomial neural fields for subband decomposition and manipulation. Advances in Neural Information Processing Systems, 35:4401-4415, 2022. 4
[69] Vickie Ye, Zhengqi Li, Richard Tucker, Angjoo Kanazawa, and Noah Snavely. Deformable sprites for unsupervised video decomposition. In Proceedings of the IEEE/CVF Conference on Computer Vision and Pattern Recognition, pages 2657-2666, 2022. 2, 3, 8
[70] Alex Yu, Ruilong Li, Matthew Tancik, Hao Li, Ren Ng, and Angjoo Kanazawa. Plenoctrees for real-time rendering of neural radiance fields. In Proceedings of the IEEE/CVF International Conference on Computer Vision, pages 5752-5761, 2021. 2
[71] Fisher Yu and David Gallup. 3d reconstruction from accidental motion. In Proceedings of the IEEE Conference on Computer Vision and Pattern Recognition, pages 3986-3993, 2014. 1, 2, 3
[72] Chengxuan Zhu, Renjie Wan, Yunkai Tang, and Boxin Shi. Occlusion-free scene recovery via neural radiance fields. 2023.

What is claimed:

1. A method comprising:
determining a plurality of images associated with a camera device;
generating a camera model indicative of the camera device in a three dimensional space;
generating, based on the plurality of images, at least one neural network trained to map input image coordinates to vectors of spline control points;
generating, based on the camera model and the at least one neural network, at least one reconstructed image; and
causing storage of the at least one reconstructed image.

2. The method of claim 1, wherein the reconstructed image modifies, removes, adds, or a combination thereof one or more of an object or a plane from one of the plurality of images.

3. The method of claim 1, wherein generating the at least one reconstructed image comprises using the at least one neural network to interpolate a color value for a pixel based on more than one spline control point associated with the pixel.

4. The method of claim 1, wherein the plurality of images are offset from each other in space due to motion of the camera device while capturing the plurality of images, wherein the at least one neural network is trained such that pixels blocked by an obstruction in one image may be reconstructed using based on pixels in another image of the plurality of images.

5. The method of claim 1, wherein the spline control points comprise locations on a polynomial function.

6. The method of claim 1, wherein the at least one neural network maps a coordinate of an image to color values at each of the spline control points.

7. The method of claim 1, wherein each spline control point represents a different point of time relative to the plurality of images.

8. The method of claim 1, further comprising receiving movement data indicative of movement while at least a portion of the plurality of images are captured, and initializing the camera model based on the movement data by specifying one or more of a location of the camera device, a rotation of the camera device, an angle of the camera device, or a translation of the camera device.

9. The method of claim 1, wherein the plurality of images comprises a sequence of images, a burst of images captured over at least 2 seconds, a burst of images captured over at least 1 second, a burst of images captured in a range of about 0.5 seconds to 2 seconds, a sequence in a range of about 10 to about 40 frames, or a combination thereof.

10. The method of claim 1, generating the at least one neural network comprises optimizing a photometric reconstruction loss.

11. The method of claim 1, wherein the at least one neural network is trained to separate a foreground feature from background in the plurality of images.

12. The method of claim 1, wherein generating the at least one neural network trained to map input image coordinates to vectors of the spline control points comprises:
generating data representing a first neural field flow for a first two dimensional plane object at a first location in three dimensional space in the cameral model; and
training the first neural field flow based on using the first neural field flow to generate an approximate image and minimizing a difference between the approximate image an image of the plurality of images.

13. The method of claim 12, wherein generating the at least one neural network trained to map input image coordinates to vectors of the spline control points comprises:
generating data representing a second neural field flow for a second two dimensional plane object at a second location in three dimensional space in the cameral model; and
training the second neural field flow based on using the second neural field flow to generate the approximate image and minimizing the difference between the approximate image and the image of the plurality of images.

14. The method of claim 13, wherein the at least one neural network comprises a first neural field flow network representing motion of at least one object in a first plane in the three dimensional space and a second neural field flow network representing motion of at least one object in a second plane in the three dimensional space.

15. The method of claim 1, wherein the at least one neural network comprises at least one neural spline field model of flow.

16. The method of claim 1, wherein the at least one neural network separates one or more foreground features from a background, wherein the one or more foreground features comprise one or more of occlusions, reflections, shadows, or noise.

17. The method of claim 16, wherein the at least one neural network comprises one or more layers comprising an obstruction layer, a transmission layer and/or a combination thereof.

18. The method of claim 1, wherein the at least one reconstructed image comprises a neural field image.

19. A device comprising:
one or more processors; and
memory storing instructions that, when executed by the one or more processors, cause the device to:
determine a plurality of images associated with a camera device;
generate a camera model indicative of the camera device in a three dimensional space;
generate, based on the plurality of images, at least one neural network trained to map input image coordinates to vectors of spline control points;
generate, based on the camera model and the at least one neural network, at least one reconstructed image; and
cause storage of the at least one reconstructed image.

20. A non-transitory computer-readable medium storing computer-executable instructions that, when executed, cause:
determining a plurality of images associated with a camera device;
generating a camera model indicative of the camera device in a three dimensional space;
generating, based on the plurality of images, at least one neural network trained to map input image coordinates to vectors of spline control points;
generating, based on the camera model and the at least one neural network, at least one reconstructed image; and
causing storage of the at least one reconstructed image.
